(19) United States
(12) Patent Application Publication
(10) Pub. No.: US 2026/0268643 A1
(43) Pub. Date: Sep. 10, 2026

(54) SYSTEMS AND METHODS FOR IMAGE CLASSIFICATION

(71) Applicant: SAMSUNG ELECTRONICS CO., LTD., Suwon-si (KR)

(72) Inventors: Umberto MICHIELI, Chertsey (GB); Mete OZAY, Chertsey (GB); Jijoong MOON, Suwon-si (KR); Hyeonmok KO, Suwon-si (KR); Eunju YANG, Suwon-si (KR); Woojong YOO, Suwon-si (KR); Kirill PARAMONOV, Chertsey (GB); Jack FOSTER, Chertsey (GB)

(73) Assignee: SAMSUNG ELECTRONICS CO., LTD., Suwon-si (KR)

(21) Appl. No.: 19/667,194

(22) Filed: May 4, 2026

Related U.S. Application Data
(63) Continuation of application No. PCT/KR2025/021924, filed on Dec. 16, 2025.

(30) Foreign Application Priority Data
Dec. 20, 2024 (GB) 2418844.3
Jun. 6, 2025 (GB) 2508955.8

(51) Int. Cl. G06V 10/774; G06N 3/0455; G06V 10/778

(52) U.S. Cl. CPC G06V 10/774; G06N 3/0455; G06V 10/7788

(57) ABSTRACT

Broadly speaking, the present techniques generally relate to a method of generating a classification machine learning, ML model comprising a base ML feature embedding model and a generative ML model for deployment to a user device and a method of using the classification ML model which has been generated. The present techniques also relate to a method of generating a training data set for training the ML generative model to improve the classification of input images, The present techniques relate to devices and systems for carrying out the methods. Advantageously, the present techniques enable class-incremental recognition of personal object classes via conditional feature-space generative modelling with near-zero forgetting.

### CROSS-REFERENCE TO RELATED APPLICATIONS

This application is a continuation application of International Patent Application No. PCT/KR2025/021924, filed on Dec. 16, 2025, which claims priority to UK Patent Application No. 2418844.3 filed on Dec. 20, 2024, and UK Patent Application No. 2508955.8 filed on Jun. 6, 2025, the disclosures of which are incorporated herein by reference in their entireties.

### FIELD OF THE INVENTION

The present techniques generally relate to methods and systems for generating and then using a classification machine learning, ML model comprising a base ML feature embedding model and a generative ML model. In particular, the present techniques provide conditional feature-space generative modelling whereby in use, the classification ML model is adaptable to 1-shot learning.

### BACKGROUND

While deep neural networks are increasingly ubiquitous, their reliance on training from independent and identically distributed (i.i.d.) data renders them vulnerable to catastrophically forgetting previous knowledge when presented with non-i.i.d. data streams. In reality, many problems are inherently non-i.i.d. due to the temporal and often transient nature of the real-world. For example, the portfolio of products, recipes, and media on offer to consumers is ever-growing, and recommendation algorithms must continue to accommodate these new options. Similarly, a deployed robot must be able to recognise new objects as the world around them changes. Class-incremental learning (CIL) is a paradigm designed to replicate such settings, whereby novel classes are introduced sequentially for the model to classify.

Another pragmatic requirement of machine learning models is the need to operate with scarce data. While deep neural networks typically assume complete data coverage, in reality data is often scarce (for example users are disinclined to provide multiple training samples). Few-shot class-incremental learning (FSCIL) extends the CIL setting to accommodate this notion of data scarcity, mandating that models learn novel classes given only a handful of samples. FIG. 1 is a schematic representation of a setup for FSCIL with K shots. A base training session is usually done on the server and multiple incremental training sessions are usually done on device with a few annotated samples (i.e., the support set) from novel classes.

As shown in FIG. 1, on the server side an initial model M_{Init} as well as the base class set (e.g., peach, apple) are identified for the base training phase. The base class set is split into base class training data

$${X}_{train}^{( 0 )} ,$$

and base class testing data

$${X}_{test}^{( 0 )} ;$$

During the base training phase, the initial model M_{Init} is trained to obtain a trained base model M_{BT}. Once trained, M_{BT} is deployed on a personal device. Optionally before the trained model is deployed to the user device, it may be compressed. On the device, a user provides at least one annotated sample for each novel class. This is called support set:

$${X}_{support}^{( 1 )} .$$

and may contain a few annotated samples from previously unseen novel classes (e.g., Asian food dishes). This leads to a continual stream of incremental training sessions, where the model adapts to novel class data and produces M_{IT}. For an incremental training session s>0, annotated (or support) samples from novel classes are denoted as

$${X}_{support}^{( s )} ,$$

test (or query) samples from novel classes are denoted as

$${X}_{q u ery}^{( s )} ,$$

the number of novel classes are denoted as Nₛ and the number of support samples (or shots) per class are denoted as K. The set of all classes may be referred to as

[symbol]

Existing prior art methods typically employ the use of nearest mean classifiers (e.g. Protonet, SAVC) or discriminative classifiers (e.g., RelationNet). Current solutions for few-shot class-incremental recognition such as these have trouble generalizing to novel classes based on a single reference sample alone. Standard semantic segmentation methods pre-trained with cross-entropy loss fail in few shot personalization. Specialized few-shot semantic segmentation methods rely on either naive nearest mean classifiers or simple discriminative classifiers which both fail in one-shot scenarios. In other words, key limitations of the state-of-the art methods may be expressed as trouble generalising to novel classes based on a single reference sample and thus requiring K>10 shots and often requiring on-device training.

However, it is suggested that in many cases learning from a single example is necessary, such as when data collection is expensive, when events are rare, or when dealing with users who want seamless interactions with machine learning agents. Related methods, for example “Few-shot class-incremental learning via class-aware bilateral distillation” by Zhao et al published in Proceedings of the IEEE/CVF conference on computer vision and pattern recognition in 2023, typically assume that they are able to access at least 5-10 samples for novel classes, which is enough to perform some meaningful updates to model parameters. Alternatively, related methods, such as “Learnable distribution calibration for few-shot class-incremental learning” by Liu et al published in IEEE Transactions on Pattern Analysis and Machine Intelligence in 2023, construct meaningful approximations of class distributions. These updates are often paired with knowledge distillation from the previous model to restore performance on past classes. Under the stringent constraints of one-shot CIL for low-resource devices, these mechanisms are insufficient because they lack strong priors for novel classes, necessitating multiple exemplars to compute meaningful class representations.

A user customized experience which provides bespoke ML models is desired. For example, the user customized experience provides discriminative AI in digital appliances and generative AI on mobile platforms. As noted above, current techniques lead to poor adaptation. The accuracy of the model on new tasks/classes is typically poor, particularly in cases where available data for the new task/class is limited to a few instances (and especially where data is limited to a single instance). This poor adaptation significantly affects the quality of service (QoS). The model may be unable to acquire new knowledge.

The present applicant has identified the need for an improved technique for performing few-shot class-incremental learning which may also be utilised in instances of one-shot class incremental learning.

### SUMMARY

In an approach of the present techniques, there is provided a method of generating a classification machine learning, ML, model for deployment to a user device. The method includes obtaining a backbone ML feature embedding model for generating feature embedding vectors of images. The backbone ML feature embedding model is associated with a set of base classes. each base class in the set of base classes has a base class prototype which is a feature embedding vector which is representative of the base class. The method includes obtaining a training dataset comprising a plurality of input images each of which has a base class label from the set of base classes. The method includes generating, using multiple input images in the training dataset, training data for the generative ML model. The generating training data for the generative ML model includes, for each input image in the multiple input images, extracting, using the backbone ML model, an input feature embedding vector for the input image. The generating training data for the generative ML model includes, for each input image in the multiple input images, selecting the prototype feature embedding vector corresponding to the base class label for the input image. The generating training data for the generative ML model includes, for each input image in the multiple input images, calculating a residual vector comprising a distance and a direction between the extracted input feature embedding vector and the selected prototype feature embedding vector in a feature space which is defined by the input feature embedding vectors for the multiple input images. The generating training data for the generative ML model includes, for each input image in the multiple input images, associating the calculated residual vector with the selected prototype feature embedding vector as an instance of the training data for the generative ML model. The method includes training the generative ML model to generate a reconstructed residual vector using the training data comprising calculated residual vectors and associated prototype feature embedding vectors. The method includes outputting the classification ML model comprising the backbone ML model and the generative ML model to a user device.

In an approach of the present techniques, there is provided an electronic device. The electronic device includes memory storing instructions. The electronic device includes at least one processor operatively coupled to memory and comprising processing circuitry. The at least one processor individually or collectively executes the instructions to cause the electronic device to perform the method of generating the classification ML model for deployment to the user device.

In an approach of the present techniques, there is provided a computer-readable storage medium comprising instructions which, when executed by at least one processor, causes the processor to carry out any of the methods described herein.

### BRIEF DESCRIPTION OF THE DRAWINGS

Implementations of the present techniques will now be described, by way of example only, with reference to the accompanying drawings, in which:

FIG. 1 is a schematic representation of a setup for standard FSCIL with K shots;

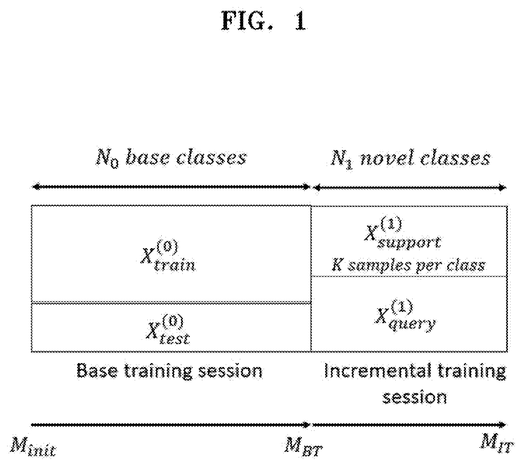

FIG. 2 is a flowchart summarising operations carried out on the server side and the device side according to the present techniques;

FIG. 3 is a closer look at the base training session of a backbone model as summarised in FIG. 2;

FIG. 4 is a closer look at the base training session of a generative model as summarised in FIG. 2;

FIG. 5 is pseudo code for an example algorithm used in generative base training;

FIG. 6 is a closer look the incremental training session as summarised in FIG. 2;

FIG. 7A shows an example input image, an incorrect classification of the input image and a user annotated classification of the input image;

FIG. 7B shows an example input image, an incorrect classification of the input image and a user annotated classification of the input image;

FIG. 7C shows an example input image, an incorrect classification of the input image and a user annotated classification of the input image;

FIG. 8A is a closer look at the inference carried out on the low-resource device side;

FIG. 8B is a closer look at an optional aspect of the inference carried out on the low-resource device side;

FIG. 9 is pseudo code for an example algorithm used in inference;

FIG. 10A schematically illustrates an embedding space with two example classes and a feature vector to be classified;

FIG. 10B schematically illustrates the embedding space of FIG. 10A showing the target residual vector once the class prototype has been subtracted;

FIG. 10C schematically illustrates the embedding space of FIG. 10B showing the relation between the reconstructed residual vector predicted by the generative model and the target residual vector;

FIG. 11A plots the feature space using a DINO-s model and show five different classes without and with inductive bias;

FIG. 11B plots the feature space using a DINO-s model and show five different classes without and with inductive bias;

FIG. 12 is a representation of some operations in FIG. 4 when training a generative model which is a diffusion model;

FIG. 13 is a representation of some operations in FIG. 8A when using a generative model which is a diffusion model;

FIG. 14 is a block diagram of a system which may be used in the present techniques;

FIG. 15A is a table comparing the results of various prior art methods and the two proposed methods (using a VAE/diffusion model) on two different databases using a base DINOv2-s or ResNet18 model;

FIG. 15B is a table comparing the results of various prior art methods and the two proposed methods (using a VAE/diffusion model) on two different databases using a base DINOv2-s or ResNet18 model;

FIG. 16 is a table comparing the results of 1-shot novel class incremental training for various prior art methods and the two proposed methods (using a VAE/diffusion model) on two different databases using a base DINOv2-s or ResNet18 model;

FIG. 17 is a table comparing the results of 1-shot novel class incremental training for various prior art methods and the two proposed methods (using a VAE/diffusion model) on two different databases using a base DINOv2-s or ResNet18 model;

FIG. 18A presents a feature space created using a DINOv2-s based model on a CORe50 dataset; each Figure shows a different four novel class embeddings alongside a base class with similar structural properties;

FIG. 18B presents a feature space created using a DINOv2-s based model on a CORe50 dataset; each Figure shows a different four novel class embeddings alongside a base class with similar structural properties;

FIG. 18C presents a feature space created using a DINOv2-s based model on a CORe50 dataset; each Figure shows a different four novel class embeddings alongside a base class with similar structural properties;

FIG. 18D presents a feature space created using a DINOv2-s based model on a CORe50 dataset; each Figure shows a different four novel class embeddings alongside a base class with similar structural properties;

FIG. 19 is a graph of density against L2 norm of residuals for the distribution of residuals from a sample to correct (positive) and incorrect (negative) class prototypes;

FIG. 20 shows a use case for the techniques described above;

FIG. 21 shows a use case for the techniques described above;

FIG. 22 shows a use case for the techniques described above; and

FIG. 23 shows a use case for the techniques described above.

### DETAILED DESCRIPTION

Few-Shot Class-Incremental Learning (FSCIL) is a paradigm in which a model, trained on some initial classes, must accommodate the expansion of the problem space to novel classes for which there is limited data. Many applications of FSCIL are likely to be in low-resource, data constrained environments. To address this setting, the most challenging FSCIL setup is considered, whereby a model is provided just a single sample for a novel class (1-shot), and where no training or alterations may be made to the AI model after the base training session. Under these constraints, generalising to novel classes is a significant challenge. A novel approach is presented that leverages generative modelling to construct a prior over the base classes that can be forward-propagated into novel class recognition. This approach is verified to illustrate that it achieves SOTA performance on multiple benchmarks and backbone architectures, yielding significantly improved novel class recognition.

Observations have been made showing that (i) natural image classes often follow a long-tailed distribution, (ii) semantically related concepts exhibit similar geometric relationships in the embedding space across different modalities, and (iii) the embeddings of novel classes may be approximated by mixing base class embeddings. From these observations arises the hypothesis that semantically related classes may have structurally similar embedding distributions under a well-generalized backbone. To exploit this in the present embodiments, a prior for novel classes is constructed by mapping class embeddings into a residual space, where embeddings are centred around their class prototypes. This enables the model to learn a single density that captures the shared class structure, even for unseen classes.

Broadly speaking, the present techniques generally relate to a method of generating a classification machine learning, ML model comprising a base ML model and a generative machine learning, ML, model for deployment to a user device and a method of using the classification ML model which has been generated. The present techniques also relate to a method of generating a training data set for training the ML generative model to improve the classification of input images. The present techniques relate to devices and systems for carrying out the methods. Advantageously, the present techniques enable class-incremental recognition of personal object classes via conditional feature-space generative modelling with near-zero forgetting. Alternatively, or additionally, the present techniques enable robust class-incremental recognition of personal object classes via conditional feature-space generative modelling. Alternatively, or additionally, the present techniques enable One-shot Class-Incremental recognition of personal object classes via conditional feature-space generative modelling. It is to be appreciated however that whilst the present teachings focus on the one-shot case, the described techniques may equally be applied in low-shot cases or indeed in more general instances where a large amount of instances are available for a particular class.

The residual vector may be termed a direction vector and similarly the prototype feature embedding vector may be termed a prototype feature embedding. In other words, there is provided a method of generating a classification machine learning, ML model for deployment to a user device, wherein the classification model comprises a backbone ML model and a generative ML model, the method comprising obtaining a backbone ML model for classifying input images, wherein the backbone ML model has a set of base class prototypes and each base class prototype comprises a prototype feature embedding which represents a known class which is recognisable by the backbone ML model, obtaining a training dataset comprising a plurality of input images each of which is labelled with a known class and obtaining a generative ML model. For multiple input images in the training dataset: the method further comprises extracting, using the backbone ML model, a feature embedding for the input image, determining the class of the input image, identifying a prototype feature embedding corresponding to the determined class and calculating a direction vector representing a distance of the extracted feature embedding from the identified prototype feature embedding. The method further comprises training the generative ML model to reconstruct the calculated vector and outputting the classification ML model comprising the backbone ML model and the generative ML model to a user device.

Each prototype feature embedding vector may be feature vector or a feature embedding which is used to identify an object as belonging to a particular class. The prototype feature embedding vector is typically generated by combining feature vectors for other objects in the same class, e.g. by generating a centroid of the features of the feature vectors within the class. A prototype feature embedding vector which is generated from a large number of feature vectors within the class will typically approximate to the true prototype feature embedding vector (i.e. the prototype feature embedding vector which is truly representative of the class). By contrast, a prototype feature embedding vector which is generated from a single (1-shot) or a few-shot (e.g. 5 or fewer) examples is not likely to be truly representative of the class. For example, such a prototype feature embedding vector is not likely to be located at the centroid of the class. The aim of the training of the generative machine learning model is to accurately reconstruct the residual vector between a feature vector of an instance of a particular class, and the true prototype feature embedding vector (typically the centroid) for that class.

Calculating the residual vector v may be done by subtracting the selected prototype feature embedding vector from the extracted input feature embedding vector, e.g. using:

$$v = {f}_{ϕ} ( x ) - c$$

where f_{φ}(⋅) is the backbone ML model, x is then input image, and c is the prototype feature embedding vector. The generative model may be represented by g_{θ}(⋅). The generated reconstructed residual vector may be represented by \hat{v}_{y}.

A feature vector is a numerical representation of the object and/or image (or part of the image). A feature vector is a n-dimensional vector of numerical features that represent the object. A feature vector may also be termed an embedding and the terms may be used interchangeably. Using prototype feature vectors means that the samples (either base samples or user-specific/new samples) do not need to be stored. This reduces the resource required on the user device to personalise the ML model but maintain accuracy.

Generating the training data for the ML model may comprise dividing the plurality of input images in the training dataset into a support set and a query set, wherein the support set and the query set each contain one or more input images of each known base class and wherein the multiple input images are the query set. The support set and the query set may be termed first and second subsets of the training dataset. Prior to generating the training data for the ML model, the method may further comprise generating, using the support set, a prototype feature embedding vector for each base class. In other words, the base class prototype feature embedding vectors for the set of base classes which is associated with the backbone ML feature embedding model may be generated from the support set. Selecting the prototype feature embedding vector corresponding to the base class label for the input image may thus comprise selecting a prototype feature embedding vector generated using the support set

A base class prototype feature vector may be referred to as a prototype for brevity. The base class prototype comprises a feature vector which represents the mean (or centroid) feature vector for all feature vectors of a particular class. In other words, the prototype feature embedding vector for each base class by identifying each image in the support set which is labelled with the base class; extracting, using the backbone ML feature embedding model, a feature embedding vector for each identified input image; and calculating a mean feature vector from the extracted feature embedding vectors, wherein the calculated mean feature vector is the prototype feature embedding vector. By calculating the prototype feature embedding vector in this way, the prototype feature embedding vector are the class means of the images in the support set, rather than the true centroids which is beneficial.

As an alternative to dividing the training dataset into a query set and a support set, the base class prototype feature embedding vectors for the set of base classes which is associated with the backbone ML feature embedding model may be generated when training the backbone ML feature embedding model. In other words, the prototype feature embedding vectors may be the true centroids. These may be generated using any suitable technique. For example, clustering may be used to group the feature vectors into groups which are in a similar location in vector space. The clustering may be done using any suitable technique, for example k-means clustering which is described for example in “An efficient k-means clustering algorithm” by Kanungo et al published in IEEE Transactions on Pattern Analysis and Machine Intelligence in 2002) or spectral clustering which is described for example in “Spectral clustering based on local linear approximations” by Arias-Castro et al published in Electronic Journal of Statistics in 2011. The method of generating the set of prototype feature vectors may comprise calculating a centroid feature vector for each cluster; and setting the centroid feature vector as the representative feature vector. The centroid of a cluster may be defined as the arithmetic mean of all the data points in that cluster.

The training of the generative ML model may be done using any suitable technique, e.g. by minimising a loss between the reconstructed residual vector and the input residual vector. By training the generative ML model using each calculated residual vector and associated prototype feature embedding vector for each class, the present methodologies utilise the distributions of feature vectors (embedding vectors) in feature space around the true prototype feature embedding vector which is representative of the entirety of that class. In other words, the generative ML model may be trained to learn the class-conditional densities. In particular, the present method leverages the fact that for each class within the same domain (e.g. fruit, vegetable, animal species, etc), the distribution of feature vectors for each object within the class around the prototype feature embedding vector is similar. For example, when considering an apple and a lemon, whilst the prototype feature embedding vector for the apple and the lemon may be noticeably distinct from one another within feature space, the distribution of individual feature vector examples (i.e. representations of individual images in feature space) around the respective prototype feature embedding vectors is similar in structure for the apple and the lemon. It is therefore reasonable to assume that the distribution in feature space around a true prototype feature embedding vector for a previously unseen novel class (e.g., an orange) will also share a similar structure. The present embodiments therefore leverage this assumption in order to enable accurate classifications for classes for which only a single instance of labelled sample data is provided and hence the “true” prototype feature embedding vector is unlikely to be obtained.

The reason that the generative model is trained to reconstruct the residual vector is that this in effect makes the generative model agnostic to the position of the particular class in feature space. By subtracting the prototype feature embedding vector (class prototype) from the extracted input feature embedding vector of the image data, this effectively places the prototype at the origin of the feature space, with the location of the image data being then placed with respect to the origin. Since this is performed for each base class, the positions of all image data for all relevant classes are then effectively provided with respect to the origin, enabling the generative model to learn the shared intra-class structures without needing to give any consideration to the actual position of the feature vector in feature space. It is this which enables the generative model distinguishing power over novel classes within the same domain and this can be achieved without requiring any specific training or adaptation of either the backbone model or the generative model to take into account a novel class over which the models have not been trained.

The generative ML model may be trained on “positive-class” residual vectors, i.e. the generative model is only trained on instances where the residual vector for the correct class is provided. In other words, the generative model is not trained on instances where the residual vector is calculated by subtracting the “wrong” prototype feature embedding vector from the extracted input feature embedding vector. The result is that when attempting to reconstruct a residual vector using the wrong class prototype (as will be seen during the operational runtime inference stage), the reconstructed residual vector will yield a high reconstruction error, allowing for the generative model to discern whether a class is a good candidate for the image data.

The generative ML model may be a variational autoencoder (VAE), for example comprising an encoder and a decoder. The encoder may be trained to learn a distribution of latent variables z over the observed data which may be only the input image x or may be a combination of the input image x and the label y. The decoder may be trained to learn a distribution of the observed data (only the input image x or combination of the input image x and the label y) over the latent variables z. Encoders can be stacked to generate a series of latents, and decoders can be stacked to reverse this process. Training the generative ML model to generate a reconstructed residual vector may comprise using an evidence lower bound (ELBO) loss. Such an ELBO loss may comprise a reconstruction loss and a prior matching loss. Reconstruction loss measures the difference between the original input data and the reconstructed output. Prior matching loss ensures the distribution of the observed data over the latent variable space matches a predefined prior distribution. In Variational Autoencoders (VAEs), these losses are typically combined to train the network.

The generative ML model may be a diffusion model which is a model mapping a Gaussian distribution to a desired distribution. A diffusion model typically comprises an encoder which gradually adds noise to an input and a decoder which gradually removes the noise to generate the output. When training a diffusion model, noise may be applied to the residual vector. In this example, a loss function using the noised sample and denoising timestep may be used. In other words, during training, the image is corrupted with noise by the encoder and the decoder may then be used to predict the noise. A loss between the predicted noise and the applied noise may be calculated and backpropagated through the model, e.g. by adjusting the parameters of the diffusion model to minimise the calculated loss. For both types of model, the generative model may be used to model class densities indirectly by learning the direction vectors.

The backbone ML model may be a pre-trained model which has been pre-trained on a larger dataset. The backbone ML model may be any suitable model, e.g. ResNet or DINO transformer. The backbone ML model may be trained specifically over a set of base classes for objects that the final classification model would be expected to classify with high accuracy. In an illustrative example, this may comprise a high-level domain of “fruit,” with individual examples of classes being apples, lemons, peaches, etc. For each instance of object data, a feature vector will be obtained which is representative of that object in a feature space. The result of this stage is a backbone ML model that is able to accurately create a feature vector for that object.

The method may further comprise training the backbone ML model using domain-specific data prior to receiving the backbone ML model. This training operation may be termed a base training phase and may be used to generate the base class prototypes.

It will be appreciated that the operations of generating training data for the generative ML model may be a separate technique. Thus, in a second approach of the present techniques, there is provided a computer-implemented method of generating a training data set for training a generative machine learning, ML, model for classifying input images, the method comprising:
obtaining a plurality of input feature vectors where each input feature vector represents an input image, wherein each input feature vector is labelled with a known class and obtaining a prototype feature embedding for each of the known classes, wherein the prototype feature embedding for a class of the known classes comprises a vector representing a mean feature vector for the class. Generating the training data set for training the generative ML model comprises, for each of the plurality of input feature vectors: calculating a residual vector comprising a distance and direction in feature space of the input feature vector from the prototype feature embedding for the known class of the input feature vector; and associating the calculated residual vector with the prototype feature embedding for the known class of the input feature vector as an instance of training data. Obtaining the plurality of input feature vectors may comprise extracting the input feature vectors from corresponding input images using a backbone ML feature embedding model.

It will be appreciated that many of the features of the first aspect apply to the second aspect are not repeated for conciseness. For example, the use of a support and query set to generate the training data may be equally applied to the second aspect.

The above training operations over the base classes will typically be performed on a system with high available computational resource (i.e. server-side). Following the training, the two trained elements (i.e. the backbone machine learning model and the generative model) of the classification model will typically be deployed for use on a user device (such as a mobile phone or a tablet). Upon deployment, both of the elements of the classification model will be frozen such that any further data which is received will not affect the parameters of the model. This has the benefit that the user device (which typically has much lower computational resource) does not need to perform any training of the models, which is a resource intensive process and therefore typically not suitable to be carried out on a user device. As part of this deployment, the base class prototypes are provided to the user device and stored on a local memory.

In a third approach of the present techniques, there is provided a computer-implemented method for using a classification ML model which has been generated as described above. The classification ML model is stored on the user device together with a set of class prototypes, each of which is in the form of a prototype feature embedding vector which is representative of the class. The method comprises receiving, at the user device, an input image comprising an object to be classified; extracting, using a backbone ML feature embedding model of the classification ML model, an input feature embedding vector for the input image and for each prototype feature embedding vector of the set of class prototypes: calculating a residual vector comprising a distance and a direction between the extracted input feature embedding vector and the prototype feature embedding vector; inputting each calculated residual vector and associated prototype feature embedding vector into a generative ML model of the classification ML model to predict a reconstructed residual vector; and calculating a similarity score between each calculated residual vector and predicted reconstructed residual vector. The method comprising outputting a predicted class for the input image based on the calculated similarity score.

We also describe a method of using a classification ML model which has been generated as described above (and optionally personalised as described below). The method may comprise receiving an input image comprising a novel object, generating, using the backbone ML model of the classification ML model. a feature embedding of the input image, determining, using the generated feature embedding, multiple candidate class prototype for the input image, calculating, for example candidate class prototype, a direction vector representing a distance of the generated feature embedding from a prototype feature embedding for the candidate class prototype; inputting each direction vector into the generative ML model and outputting, from the generative ML model a class for the input image.

It is during deployment that the model will typically first encounter instances of novel classes within a domain. Upon the first encounter with an object in a novel class, the models provided will be unable to accurately classify the object, since no label will exist within the models in order to identify the object. It is to be appreciated that a user may not necessarily be aware that they are providing image data which falls within a novel class. As such, they may not initially provide such image data with a label and thus the feature vector for the image data may not initially be stored as a prototype for that novel class. Consequently, the generative model may operate on the assumption that the newly provided novel class in fact belongs to a previously encountered base or novel class and attempt to classify the image data as described above. The result of this will be the selection of the class for which the reconstructed residual is most similar to its corresponding calculated residual (which will not be correct).

In order to mitigate against this, in some embodiments, a threshold similarity score may need to be achieved in order for a class to be selected. In instances where this similarity score threshold is not met, the user may be prompted (via their user device) to provide a label for the item and the previously calculated feature vector for the image data may then be stored as a prototype for the class, where the class itself comprises the label provided by the user. In other words, the method may comprise comparing each similarity score to a threshold similarity score; and when at least one similarity score is greater than or equal to the threshold, outputting the predicted class having a highest similarity score and when all similarity scores are lower than the threshold, prompting a user to provide a label for a new class for the input image. The prompt may also be used following user feedback that an output predicted class for the input image is inaccurate.

To that end, where an object in a novel class is provided, it will typically also be required to provide a label for that object. The labelled novel class is firstly provided to the underlying trained classification model (which is frozen to prevent any changes to the model) in order to generate a feature vector for this image data. This feature vector is then used as the prototype (centroid) for the novel class as a whole and is stored locally on the user device with the provided class label alongside the existing base classes. This is analogous to the “incremental” stage of training of existing approaches to training of novel classes. However, in this instance, all that is required in order to classify any future instances of the novel class is to store the feature vector of the image data and assign it as the prototype of the novel class, with no adaptation of the parameters of the machine learning models required. As such, this approach to adapting the trained model to be able to classify newly encountered classes is particularly resource efficient. This approach may be repeated for every instance of a novel class being encountered, with the feature vector for the labelled novel class being stored in each case. In this manner, the capability of the classification machine learning model is increased to be able to recognise an ever-expanding number of novel classes.

The method may comprise receiving an input image with a label for a new class; extracting using the backbone ML feature embedding model of the classification ML model, a feature embedding vector for the image; and storing, in the set of class prototypes, the extracted feature embedding as a prototype feature embedding for the new class. By new (or novel) class, it is meant a class for which the backbone ML feature embedding model has no prototype feature embedding vector within the set of base prototypes which were used during the generating of the classification ML model. By adding the novel class prototype to the set of prototypes, the set now contains prototypes for both novel and base classes. In this way, the classification ML model may be considered to be personalised to the user device, albeit without changing any parameters of the backbone ML model or generative ML model within the classification ML model.

This personalisation may be a stand-alone feature. Thus, in another approach of the present techniques, there is provided a method of personalising a ML model (i.e. generating a personalised classification ML model), the method comprising receiving a classification ML model which has been generated as described above, receiving a single image comprising an object together with a novel class for the object, generating, using the backbone ML model of the classification ML model. a feature embedding of the single image and storing the feature embedding of the image as a prototype feature embedding for the novel class in the set of prototype feature embeddings.

It is to be noted that whilst the above methodology is able to function effectively using a single instance of image data for the novel class, where additional instances are available, these may be used to provide a more accurate estimation of the centroid for the novel class. In particular, a mean feature vector may be calculated over the entirety of the received image data for the novel class and this mean feature vector may replace the feature vector of the single instance of novel image data, to be used as the prototype for the novel class. This may provide a more accurate estimation of the centroid of the class and therefore may yield more accurate results when using the generative aspect of the model.

In other words, the present techniques may be expressed as class-incremental recognition of personal object classes via conditional feature-space generative modelling with near-zero forgetting. Such an approach allows continuous class-incremental recognition without forgetting of old samples. Generative modelling is used for improved transfer learning to novel classes, leading to increased novel class recognition accuracy. Updating only the class prototype list mitigates the forgetting rate. Advantageously, the present techniques enable software on user devices/appliances (phones, vacuum, fridge, oven, etc.) to adapt recognition to novel personal object classes while maintaining overall Quality of Service. This is done even though users are providing only one example per novel concept. In other words, the present techniques enable continuous class-incremental recognition mechanism for the system without degrading the accuracy on the old samples. By contrast, prior art solutions are typically based on static models, model fine-tuning with personal images on device and/or using base images with personal images while fine-tuning on device. Typically, such solutions need more than 5 samples. Such prior art solutions typically have low novel class accuracy or degrading accuracy on old samples (forgetting).

In other words, the present techniques may also or alternatively be expressed as robust class-incremental recognition of personal object classes via conditional feature-space generative modelling. Such an approach allows continuous class-incremental recognition robust to image noise and distortions. Generative modelling with denoising components may be used for improved noise awareness, leading to increased robustness with respect to image noise and blur. Advantageously, the present techniques enable software on user devices/appliances (phones, vacuum, fridge, oven, etc.) to adapt recognition systems to novel personal object classes and perform classification even for distorted images (e.g. due to blurring). In other words, the present techniques enable continuous class-incremental recognition mechanism for the system robust to image distortions. By contrast, prior art solutions are typically based on static models, model fine-tuning with personal images on device and/or using base images with personal images while fine-tuning on device. Typically, they fail for blurry images or require significant memory requirements.

In other words, the present techniques may also or alternatively be expressed as One-shot Class-Incremental recognition of personal object classes via conditional feature-space generative modelling. Such an approach allows continuous class-incremental recognition with just a single annotated user sample for novel class (a.k.a. one-shot scenario). Generative modelling is built to reduce the variations due to novel class prototype choice, thus improving one-shot novel class recognition accuracy. Advantageously, the third aspect of the present techniques enable software on user devices/appliances (phones, vacuum, fridge, oven, etc.) to adapt recognition systems to novel personal object classes without requiring many annotated samples. In other words, the present techniques enable data-efficient continuous class-incremental recognition mechanism. By contrast, prior art solutions are typically based on static models, model fine-tuning with personal images on device and/or using base images with personal images while fine-tuning on device. Typically, all state-of-the art (SOTA) methods require 5-10 personal samples per class.

In another approach of the present techniques, there is provided a user device comprising at least one processor coupled to memory, wherein the at least one processor is configured to carry out the method of personalising the classification ML model received from the electronic device and/or using the classification ML model.

The features described above with respect to the first approach apply equally to the other approaches and therefore, for the sake of conciseness, are not repeated.

Similarly, for all aspects, extracting a feature embedding vector for the image may comprise extracting a feature embedding vector for an object in the image, for example by determining a bounding box for the object in the image; and generating a feature vector for contents of the determined bounding box. Outputting the predicted class may comprise: modifying the input image to include the bounding box and the output predicted class and outputting the modified image. The modified image may be a cropped image which is cropped to show the part of the image within the bounding box or may be a modified image in which the bounding box has been superimposed on the original image. A bounding box is a rectangle which is drawn round a region of interest, e.g. an object in the image. Determining a bounding box may be done using any suitable technique, for example by including an object detection network in the pre-trained vision ML model. An example of a suitable object detection network is YoloV8 described in “Ultralytics YOLOv8” by Jocher et al. published on Github in 2023.

The user device and/or electronic device comprise at least one processor and memory storing instructions that, when executed by the at least one processor individually or collectively, cause the user device and/or electronic device to carry out the methods described above.

The user may be a smart device. The user device may be a smartphone. A smartphone is an example of a smart device. The user device may be a smart appliance. A smart appliance is another example of a smart device. An example of a smart appliance is a smart television (TV), a smart fridge, a smart oven, a smart vacuum cleaner, a smart robotic device, a smart lawn mower, and so on. More generally, the user device may be a constrained-resource device, but which has the minimum hardware capabilities to [personalise a trained ML model, and to use the personalised ML model]. The user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge, smart vacuum cleaner, smart lawn mower, smart oven, etc). It will be understood that this is a non-exhaustive and non-limiting list of example devices.

For example, the method may enable a smart fridge to detect new objects which have been inserted by the user, while maintaining recognition accuracy for old objects. The smart fridge may use the classification to recognise when items are running low in the fridge and may thus output a recommendation to order more food or even automatically place an order. As another example, the method may enable a robot vacuum cleaner to detect new user items/pets and avoid them while cleaning (e.g. because some pets are scared). As another example, a smart oven may be able to recognise new cuisines/dishes inserted by the user and may recommend/initiate a correct cooking program. As another example, a smart washing machine may be able to recognise new clothes inserted by the user and may recommend/initiate a correct washing cycle. Thus, the user device may make a recommendation for control of the user device and/or control the user device based on the predicted class.

The electronic device may be a server. The electronic device may be any suitable computer or computing device or combination of such devices.

In the cases where the present techniques are implemented or executed on a device comprising multiple processors, the present techniques may be implemented by one or more of the multiple processors. That is, the present techniques may be implemented by or executed by the processors individually or collectively.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general-purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the operations of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the operations of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

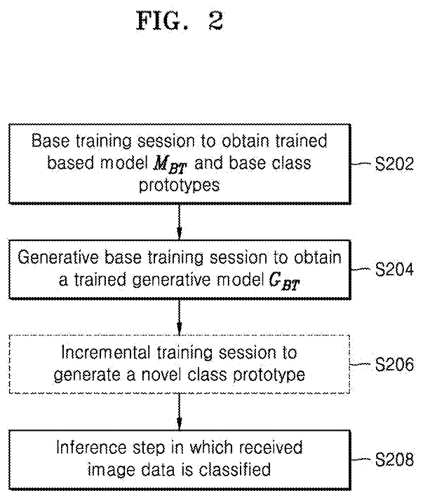

FIG. 2 is a high-level flowchart illustrating the overall operations of the present system. At operation S202, there is a base training session in which an initial backbone machine learning ML feature embedding model Mᵢₙᵢₜ is trained using a set of base class images to obtain a trained model M_{BT} and a set of base class prototypes is also generated. It is to be appreciated that in some instances, this training may be unnecessary as the initially obtained model may already be suitable. Each base class prototype is a feature vector which is representative of all objects in a particular base class (e.g. a centroid or mean vector as explained in more detail below). At operation S204, there is a generative base training session to obtain a trained generative model G_{BT} from an initial generative model Gᵢₙᵢₜ. As explained in more detail below, the generative models a feature space for each base class. There is no alteration to trained model M_{BT} at operation S204. Both these operations will typically be performed on a high-performance machine e.g., a server. Following this operation, the two trained models M_{BT} and G_{BT} form a classification ML model which may then be used during runtime on a user device in accordance with embodiments described here for the purposes of image classification. Before deployment to the user device, the two trained models may be optionally compressed.

The next operations are performed at a user device which has been provided with the classification ML model. Specifically, at operation S206 there is an incremental training session in which image data for a novel class (i.e., one which has not been seen during either base training session) is obtained a novel class prototype is generated and stored for the novel class. At operation S208, the classification ML model is used to classify a received image at the user device. The classification will assign to the image to one of the base classes or any novel classes which have been added since the base training sessions.

A set of classes [symbol] is considered where each class k∈ [symbol] is associated to a set of sample-label dataset pairs [symbol] ={Xₖ,Yₖ}, where Xₖ is the input image and Yₖ is the output classification. The following definitions are utilised herein:
Base classes: The set of classes [symbol] available at base training sessions, before the model has been deployed, and for which there is abundant training data. The dataset associated to [symbol] is split randomly into train and test sets,

$${𝒟}_{train}^{( b )} = \{ {X}_{train}^{( b )} , {Y}_{train}^{( b )} \} and {𝒟}_{test}^{( b )} ,$$

respectively.

Novel classes: The set of classes [symbol] available after base training on base classes, and for which data is scarce. The dataset associated to [symbol] is split randomly into support set

$${𝒟}_{support}^{( n )} = \{ {X}_{support}^{( n )} , {Y}_{support}^{( n )} \} ,$$

used to generate prototypes, and a holdout query set

$${𝒟}_{q u e r y}^{( n )}$$

for evaluation.

Based on these two classes, there are two key metrics:

Base class recognition: accuracy on the test split of base classes,

$${𝒟}_{test}^{( b )}$$

after the base training session.

$$BCR : = A C C ( f ( . ) ; {𝒟}_{test}^{( b )} ) .$$

where f is the overall classification model (including both base model and generative model for the proposed techniques); and

Novel class recognition: accuracy on the novel class query samples after incremental training.

$$NCR : = A C C ( f ( . ) ; {𝒟}_{q u e r y}^{( n )} ) . \qquad ( 2 )$$

Where ACC(M; D) is denoted as the recognition accuracy of model f(⋅) on data split D. Note that NCR depends on the number of novel classes N₁ and the number of support samples K.

### Base Training of Backbone

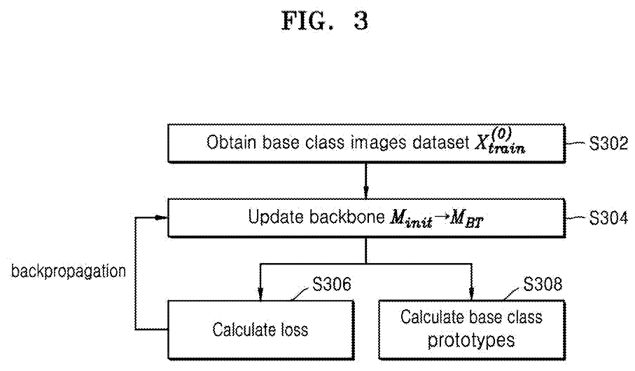

FIG. 3 shows more detail of the initial base training session of FIG. 2. in accordance with prior art techniques, the proposed Few-Shot Class-Incremental Learning (FSCIL) pipeline starts with an initial backbone model Mᵢₙᵢₜ, which may have been pre-trained on larger datasets (e.g., ImageNet-1k which is described for example in “Imagenet: A large-scale hierarchical image database” by Deng et al. published in IEEE Conference on Computer Vision and Pattern Recognition in 2009 using either a cross-entropy loss (e.g., ResNet described in “Deep residual learning for image recognition” by He et al. published in CVPR in 2016 or a self-supervised contrastive loss (e.g., DINO Transformer described for example in “Dinov2: Learning robust visual features without supervision by Oquab et al. published in arXiv in 2023.

The model undergoes a base training phase on domain-specific data, focusing on a fixed set of base classes with abundant samples (typically, >>100 per class). Thus, as shown at operation S302, a training dataset denoted as

$${X}_{train}^{( 0 )}$$

is obtained from any suitable server or database. This training dataset comprises a plurality of images which have been labelled with at least one base classification c (each classification may indicate a class of an object within the image. The training dataset

$${X}_{train}^{( 0 )}$$

may be considered to contain domain-specific data and the domain may represent an intended use of an apparatus upon which the model is to be deployed. Merely as an example, a suitable set of training data for food is Food-101 which is described for example in “Food-101—mining discriminative components with random forests” by Bossard et al. published in Computer vision ECCV 2014. Food 101 comprises 101 different classes of objects in the form of different types of food. The domain “food” will be useful for apparatus such as fridges or ovens. As an example, when the apparatus is a smart appliance such as a lawn mower, the training data may be labelled images of flowers such Flowers-102 which is described in “Automated flower classification over a large number of classes” by Nilsback et al published in 2008 in Sixth Indian Conference on computer vision. Flowers-102 comprises 102 different classes of objects in the form of different types of flowers.

At operation S304, the initial ML model is updated/trained using the training dataset

$${X}_{train}^{( 0 )} .$$

The output of this phase is the domain-specific model M_{BT}, trained on the base classes. The ML model which is trained during the base training session may be any suitable model such as MobileNet-V2 which is described for example in “MobileNetv2: Inverted residuals and linear bottlenecks” by Sandler et al published in European Conference on Computer Vision in 2022, or DINO-v2 which is described for example in “Dinov2: Learning robust visual features without supervision” by Oquab et al. published in arXiv:2304.07193. The base class train split is denoted as

$${X}_{train}^{( 0 )} ,$$

the base class test split is denoted as

$${X}_{test}^{( 0 )} ,$$

and the number of base classes as N₀.

The ML model may be updated in any suitable way, for example by calculating any suitable loss at operation S306 and backpropagating the loss into the initial ML model to adapt the parameters to minimise a loss between the prediction from the ML model and the label on the training data. As explained in more detail below, the inference stage is agnostic to the choice of the training procedure during this base training session. To evaluate effectiveness of the present inference method, it is applied on top of two base training procedures: the popular ProtoNet training which is described in “Prototypical networks for few-short learning” by Snell et al published in Advances in neural information processing systems and the state-of-the-art SAVC training described for example in “Semantic-aware knowledge distillation for few-shot class incremental learning” by Song et al published in Proceedings of the IEEE/CVF conference on computer vision and pattern recognition in 2023. In knowledge distillation, a larger ML model may be used to train the ML model which is to be deployed on the user device wherein the larger ML model may have been pretrained. Merely as an example, a suitable larger ML model may be the MobileNet-V2 and a suitable smaller ML model may be DINO-v2.

As shown in FIG. 3, there is an operation of calculating base class prototypes S308 using the trained model to generate at least one feature vector. This technique is used in both methods referenced herein, as well as most current FSCIL methods. A prototype feature vector may be termed a representative feature vector for the class. A feature vector is a numerical representation of the object and/or image (or part of the image). A feature vector is a n-dimensional vector of numerical features that represent the object. A feature vector may also be termed an embedding. The feature vectors for each image in the plurality of images form a vector space which may be termed a feature space. The prototype feature vector may be a feature vector which is selected from the generated feature vectors or may be calculated from one or more combinations of the generated feature vectors. A prototype is a feature vector which represents the class and may be determined as a centroid of the feature vectors for a given class, for example using:

$${proto}_{c} : = {Avg}_{i} ( M ( {x}_{c}^{i} ) ) ,$$

where M is a backbone model, and

$${x}_{c}^{i}$$

are annotated samples from class c.

Alternatively, the class representatives in the feature space may be expressed as: [symbol] and each class representative may be defined as the centroid (mean) of the class-wise features:

$${c}_{k} : = \frac{1}{\vert {F}_{k} \vert} {\sum }_{x ∈ {F}_{k}} f ( x ) , ∀ k ∈ 𝒦 ,$$

where |⋅| denotes the cardinality operator. For base classes, Fₖ represents training samples for class k from

$${X}_{train}^{( b )} .$$

For novel classes, Fₖ represents the unique training sample for class k from

$${X}_{support}^{( n )} .$$

In this expression, f(x) represents the base model which has also been termed M(x), it will be appreciated that the terms can be used interchangeably. Thus, a distinction can be drawn between the empirical prototype cₖ and the true centroid μₖ. For base classes, prototypes are computed using a large training set, hence cₖ≈μₖ. For novel classes, instead, prototypes are computed using the single exemplar provided. Nonetheless, such new class prototypes enable efficient classification without requiring parameter updates to the backbone model due to the use of the generative model as explained in more detail below.

As shown in FIG. 3, the base class prototypes are used in the determination of the loss in operation S306. While ProtoNet employs prototypical loss, which is more effective and robust for few-shot learning applications, SAVC uses contrastive learning and augmented base classes in the base training session to effectively partition the feature space. ProtoNet employs prototypical loss, which is a contrastive loss that pulls intra-class samples closer together and pushes inter-class samples further apart and may be expressed as:

$${p}_{ϕ} ( y = k \vert x ) = \frac{exp ( - d ( {f}_{ϕ} ( x ) , {c}_{k} ) )}{{\sum }_{{k}^{′} ∈ {𝒞}_{n e g}} exp ( - d ( {f}_{ϕ} ( x ) , {c}_{{k}^{′}} ) )}$$

where f_{φ}(⋅) is a backbone model, d is a distance function d: [symbol] →[0, ∞), and [symbol] .

Each of operations S304, S306 and S308 results in an update to the model backbone, the set of base case prototypes (denoted as [symbol] —which may be termed the base classification database) or the calculated loss. After base training stage, the base class prototypes are stored in memory for use during future stages, e.g. during base training of the generative models and inference on the user device.

The described method is focused on learning a generative prior that is valuable at inference stage. It is, in principle, agnostic to the choice of base training procedure of the embedding model, provided such training satisfies the assumptions of the proposed method. These assumptions are two-fold:
i. Class embeddings are reasonably separated
ii. Class embeddings share similar structure
   Base Training Session with Generative Models

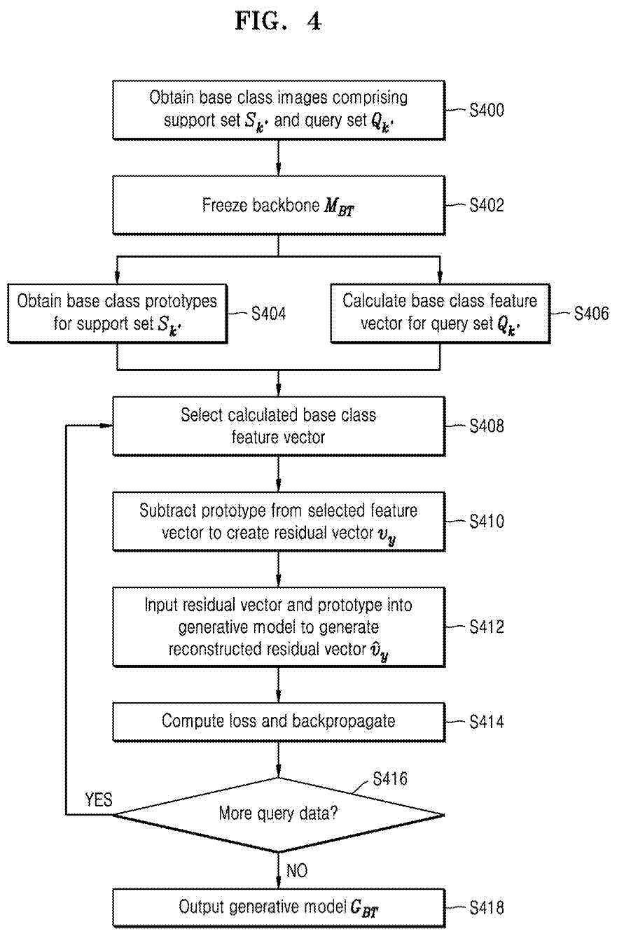

FIG. 4 is a flow chart showing more detail of the training of a generative model for use in the proposed classification model. Classification tasks typically rely on discriminative models that capture conditional probabilities p(Y|X). By contrast, generative models capture the joint probability distribution p(X,Y). The goals of the proposed system include personal data efficiency: 1<K<5 shots, stable on-device implementation: no device-time training and improved novel class recognition rate. A new pre-training stage (or generative base training session) is introduced, and then the inference operations are augmented with a generative model (e.g., a diffusion model or a VAE).

The central hypothesis of the proposed method is that related methods have very weak priors over novel classes. This mandates access to more novel class data to successfully classify such samples. To address this, it is posited that for a well generalized embedding model, novel class embeddings may have similar distributions to the base class. For example, it is known that classes of natural images have a long tail distribution. If the backbone is well generalized and the base and novel classes both belong to the set of natural images, then there is a reasonable chance their distributions will bear some similarity to one another. It is speculated that novel images may be translations of base classes (i.e., same structure but shifted means), such that the intra-class distribution is very similar, but the shifted means enable a well-separated and informative embedding space.

If such a hypothesis holds, an informative prior over the base classes can be learned to facilitate classification of novel data downstream. FIG. 4 is a closer look at the generative base training session which is carried out server side.

As explained in more detail below, the proposed techniques use generative models. For example, the generative models may include denoising diffusion models. The generative models may have much higher capability to learn distribution of data within a class. The generative models may generalize much better to novel classes. As explained in more detail below, the proposed generative diffusion model learns to project the noised vectors onto the class surface. As a result, the model may learn geometric structure of class point cloud. Diffusion model inference works well with backbones which produce similar point clouds for different classes, for example DINOv2 transformer model. Since the knowledge of the geometric structure of the point cloud is transferred to novel classes, the diffusion model works very well on one-shot classification tasks. Generative models have much higher awareness of signal vs noise in feature space. Consequently, the higher awareness contributes to improving robustness of the classification to the image noise.

Formally, it is assumed that:

$$f ( x ) \vert {k}_{n} {\approx }_{dist} f ( x ) - {μ}_{n} + {μ}_{b} \vert {k}_{b}$$

where f(x)|kₙ is the embedding given that the true class of x is kₙ, and ≈_{dist} implies that the distributions are related by a translation μₙ−μ_{b}. Under this assumption, a generative model trained on the residuals of base classes vₖ=f(xₖ)−cₖ could generalize to novel classes by learning the shared intra-class structures, provided that cₖ≈μₖ,∀k ∈ [symbol] . This condition enables the successful reconstruction of novel class residuals.

Following from this hypothesis, the objective is for a generative model g_{θ}(⋅) to learn the class-conditional densities p(f(x)|k),∀k∈ [symbol] . It is assumed that a prototype cₖ captures the central tendency of the embeddings for class k, and the intra-class embedding distributions p(f(x)|k), ∀k∈ [symbol] share a common structural property, which is captured through a non-linear transformation [symbol] by

$$f ( x ) \vert k = {μ}_{k} + 𝒯 ( z ) , z ∼ p ( z )$$

where z is a latent variable drawn from a shared base distribution p(z). The residual embedding relative to the class prototype is:

$${v}_{k} = f ( x ) \vert k - {c}_{k} \approx ( {μ}_{k} + 𝒯 ( z ) ) - {c}_{k} \approx 𝒯 ( z ) .$$

Thus, residual embeddings are independent of class-specific information, enabling a model trained on the residual density, p(vₖ|cₖ)=p(v), to perform one-shot generalization on novel classes. In practice, the one-shot setting means that novel class prototypes are often not the true centroid. Providing g_{θ}(⋅) with the candidate class prototype cₖ as context alongside the residual vₖ allowed the model to better reduce the estimation error.

At operation S400, images for labelled base classes are obtained. These may be the same images used to train the feature embedding model or different images. Specifically, the obtained images are split into two subsets: a support set Sₖ, and a query set Q_{k′}. The uses of each of these will be discussed further below. The method continues at operation S402 by freezing the trained backbone feature embedding model. Freezing the model simply refers to the parameters of the model no longer being modified as a result of supply of image data (i.e., the model is no longer undergoing training).

The method proceeds by obtaining, at operation S404, base class prototypes for the designated support set S_{k′}. They may be calculated using the standard techniques, e.g. by inputting each image data from the support set into the frozen base feature embedding model to obtain a feature vector for each image. Then, for each class, the feature vectors of the image data relating to that class will be used to generate a base prototype feature vector. In an embodiment, the base prototype feature vector may be obtained by calculating the centroid of all feature vectors for that class. When obtaining the base class prototypes, there may be a simultaneous operation S406, where a feature vector is obtained for each image in the query set Q_{k′}. This again is performed by passing the relevant image data through the frozen feature embedding model in a similar manner as is performed for the support set. It will be appreciated that each base class feature vector may be obtained after or before obtaining each base class prototype.

In other words, g_{θ}(⋅) is trained in an episodic fashion, where a subset of classes from the wider distribution is sampled, and for those classes sample a support set [symbol] and query set Q. Centroids are then calculated as the class means of the images in [symbol] , rather than the true centroids. Q are the input samples that are trained over.

At operation S408, one calculated base class feature vector is selected and at operation S410, the prototype feature vector for the class that the image from which the base class feature vector has been calculated is subtracted from the selected calculated feature vector. This creates what will be termed herein as a “residual vector” v_{y}. The calculated residual vector and the prototype for the class are used as input, at operation S412, to the generative model which generates a reconstruction of the residual vector \hat{v}_{y}.

The ultimate goal is to model the class densities p(x|c)∀c∈C, which can be accomplished with a generative model such as a VAE or Diffusion model. However, directly learning these densities would lead to novel classes being out of distribution for the generative model, and likely performance degradation. To minimise distribution shift, and to improve the forward propagation of the learned prior, the assumption that the base classes are translations of each other is leveraged, and the inputs are centered on the class means. Concretely, for a backbone f_{φ}(⋅), an input image x, and a corresponding correct class prototype c, the input to the generative model, g_{θ}(⋅) is obtained via the following:

$$v = {f}_{ϕ} ( x ) - c$$

This centers all classes at 0, and if the structure of the distributions of each class' embeddings are the similar, then the distributions of v will be the same for all classes. In such instances, the model is learning a valuable prior over the base classes that can be used at inference time for novel classes. The generative model itself is trained in order to accurately reconstruct the residual vector for a particular class. In this manner, the generative model indirectly learns the structure of the base classes, whilst being agnostic to their position in feature space. This will be discussed in further detail below.

The training may be done using any suitable technique. For example, as shown at operation S414, the loss between the generated reconstructed residual vector \hat{v}_{y} and the input residual vector v_{y} is calculated and backpropagated through the generative ML model in accordance with known techniques. This enhances the accuracy of the generative model to be able to accurately reconstruct a residual vector between a feature vector of an input image and its true class prototype vector.

It is then determined whether more query set data is available at operation S416. In particular, the present methodology is intended to provide enough query data to enable an accurate reconstruction of the residual vector to be made across all required base classes. As such, the query data will typically include multiple examples of each base class. Where it is determined that there is more query data available, the method returns to operation S408. Where there is no more query data, the generative ML model is treated as trained and is output at operation S418. The outputting of the model will typically comprise deploying both G_{BT} and M_{BT} (i.e. the full classification model) to a user device such as a mobile phone. In an embodiment, each element of the classification model may be deployed to a user device to which it is intended for use.

In summary, FIG. 4 shows one method for training the generative model to learn the direction vectors from the correct class centroid to the sample, indirectly learning the base class densities p(x|c)∀c∈ [symbol] in a way that can be forward propagated to novel classes at inference time. The residual embeddings (residual vectors) are calculated in accordance with the objectives discussed in the Variational AutoEncoder Preliminaries and Diffusion Model Preliminaries sections below for VAE and Diffusion generative models respectively. For example, if g_{θ}(⋅) is a Diffusion model, v is first noised to \hat{v}, and then the model is trained via the ELBO loss detailed below, again substituting \tilde{v} for x.

An interesting property of this training is that only positive samples are utilised, in a departure from the contrastive training regimes that are commonplace in FSCIL. In other words, the generative model is trained to exclusively reconstruct a point that lies on the class surface. Thus, the positive class conditioning will perform well and reconstruct a point very close to the query embedding when used at inference. By contrast, the use of negative classes would reconstruct a direction vector to the point on the class surface closest to the query. For a well-separated embedding space, this distance will be very large, leading to large denoising errors for the diffusion model, and low log-likelihoods for the VAE. Thus, the generative model should be able to successfully and reliably classify samples from both novel and base classes.

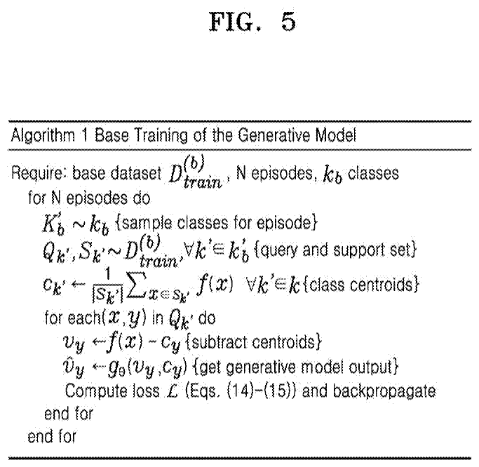

FIG. 5 is an example pseudocode showing an algorithm for base training of the generative model as explained with reference to FIG. 4. The references to equations 14 and 15 in the pseudocode are to the loss equations for the VAE and diffusion models respectively. In FIG. 5, the base training dataset is split into a query and support set Q_{k′}, and S_{k′} and the residual vector v_{y} is obtained by subtracting the centroids c_{y} which have been calculated using the support set from the feature vector created using the backbone model f(x). The predicted residual vector \hat{v}_{y} is obtained by imputing each centroid c_{y} and associated residual vector v_{y} into the generative model g_{θ}(⋅).

### Incremental Training Session(s)

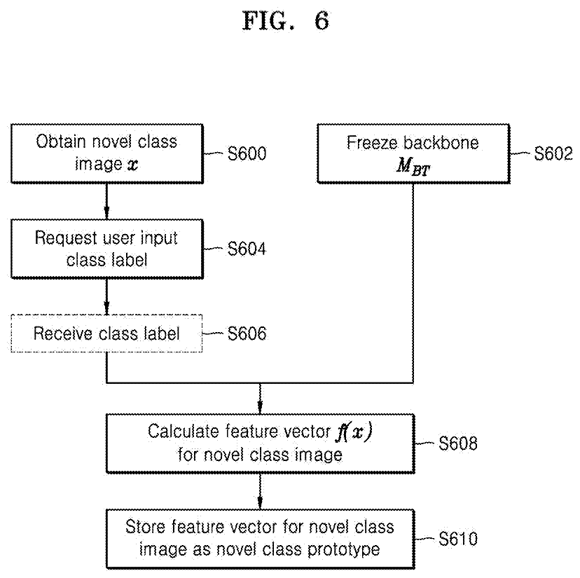

Referring now to FIG. 6, there is shown a more detailed description of optional operation S206 of FIG. 2. Specifically, this details how the classification model received by the user device (or other appropriate device) is personalised to enable the classification model to also be able to classify objects of a class not encountered by the classification upon training (i.e. a novel class). In other words, this part is carried out on the low-resource device side i.e. at a user device. Since the current consideration is a 1-shot setting, the backbone is frozen during incremental training because changes to the backbone will lead to distribution drift for the proposed generative model with little other benefit. Generated prototypes are saved to memory and appended to the list of existing prototypes. It is to be noted that this form of incremental training differs from standardly known forms of incremental training, in that the classification model (specifically the backbone feature generation portion of the model) is not updated. The incremental aspect relates merely to adding additional class prototypes for received novel classes. The generative model g_{θ}(⋅) is not employed at this stage.

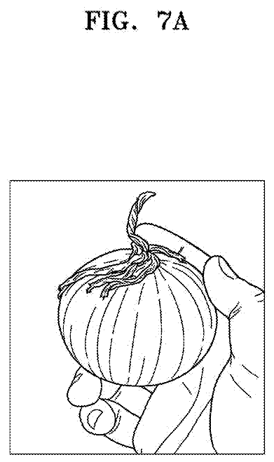

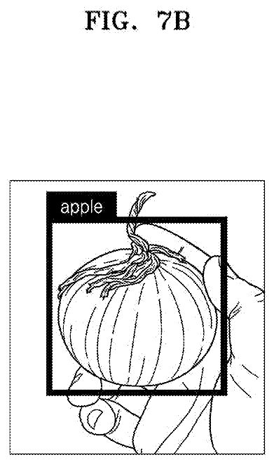

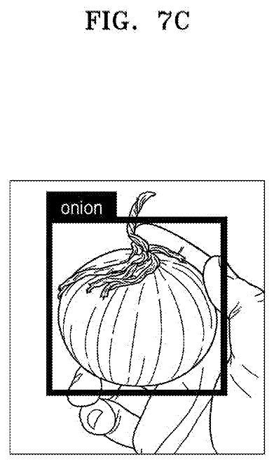

The method begins at operation S600 when image data comprising an object of a novel class is received at the user device. This image data will typically be provided with a label indicating the novel class (e.g. “onion”). Merely as an example, FIG. 7A shows an example of an image belonging to a novel class. When the image is not labelled or an incorrect label is output for example as shown in FIG. 7B, as shown at operation S604, there is an optional operation to request a user input of a class label. The subsequent operation S606 of receiving the class label from a user is shown at FIG. 7C. The user input and request may be done using any standard techniques. For example, FIGS. 7A to 7C show the well-known technique of bounding boxes around the object within the image. Moreover, the classification is output together with the image, in other words, an edited version of the input image is generated by the process.

When the image is received, as shown at operation S602, the backbone of the feature embedding model M_{BT} aspect of the received classification model is frozen. At operation S608, a feature vector is calculated for the novel class image using the feature embedding model M_{BT}. This simply involves providing the novel image data to M_{BT} and receiving the feature vector as an output in a manner analogous to approaches described above. Following this, the obtained feature vector is stored, at operation S610, as a class prototype feature vector for the novel class.

There may be more than one image received and thus, the operations of FIG. 6 may be repeated for each novel class image. In other words, during this phase, the prototypes are computed and stored for novel classes ( [symbol] ) from their support samples in

$${X}_{support}^{( 1 )} .$$

In the proposed 1-shot setup, the cardinality of the novel class support set is 1. Whilst it is unlikely that the calculated feature vector is an entirely accurate representation of the true centroid of the novel class, the approaches adopted herein mean that this lack of accuracy does not detract from the performance of the model in identifying the novel class in future uses of the classification model.

### Inference Stage: Conditioned Generative Modelling

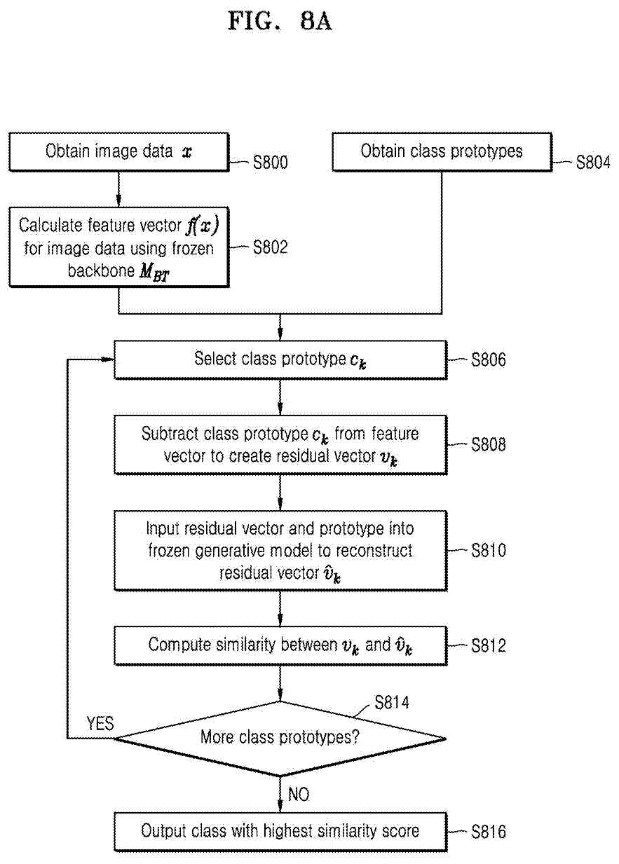

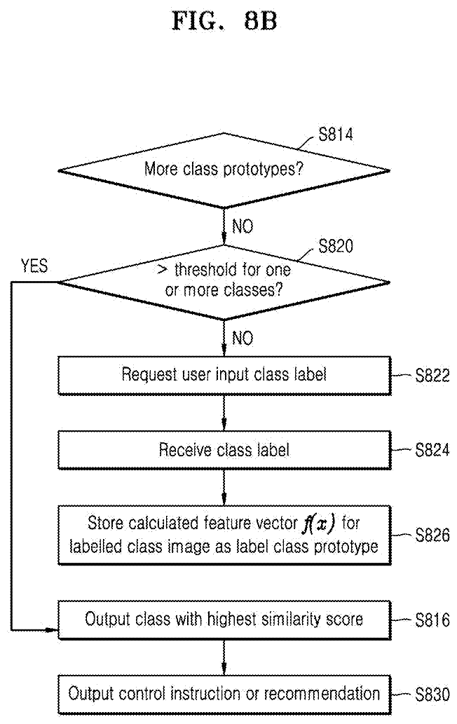

Referring now to FIG. 8A, there is illustrated in further detail operation S208 of FIG. 2 i.e. the use of the classification ML model when deployed on the user device and receiving image data for classification. In other words, FIG. 8A is a closer look at the interference (use) of the classification model, carried out on the low-resource device side.

The approach begins at operation S800 where image data for classification is received at the user device upon which the classification model is deployed. The image data may be received from a user, e.g. by selection from a gallery app or by taking a photo, or may be received from an app, e.g. when a user opens the app. At this stage, the classification model is being used rather than trained and so all parameters within the model should not be affected by the received image data. Thus, at operation S802, a feature vector is calculated for the image data using the frozen feature embedding model M_{BT}. This simply involves providing the novel image data to M_{BT} and receiving the feature vector as an output in a manner analogous to approaches described above.

When calculating the feature vector, at operation S804, the class prototypes are obtained. This operation may be done before or after the calculation of the feature vector. The class prototypes may be retrieved from a data store on the user device. This set of class prototypes may include any of the base class prototypes stored upon training of the feature embedding model M_{BT}. This set of class prototypes may also include any calculated novel class prototypes generated in accordance with the methodology of FIG. 6.

For each prototype in the obtained set of prototypes, first a prototype cₖ is selected at operation S806 and then subtracting from the calculated feature vector at operation S808. The result of this operation is the creation of a residual vector vₖ representing the distance and direction of the calculated feature vector to the class prototype. At operation S810, the presently calculated residual vector and the class prototype used to obtain this residual are inputted into the generative model in order to calculate a reconstructed residual vector \hat{v}ₖ. This is then followed by the calculation of the similarity (typically a similarity score) between the calculated residual vector and the reconstructed residual vector \hat{v}ₖ at operation S812.

The fact that the generative model has only been trained on “positive” residual vectors (i.e. residual vectors between a feature vector and its correct class prototype) means that the generative model has a good ability to discern between correct and incorrect classes. In particular, when attempting to reconstruct a residual vector which has been initially created using the wrong class centroid (i.e. for a 1-shot novel class), the generative model attempts to correct the position and distance of the residual vector as a result of the training. This leads to a low similarity between the calculated residual vector and the reconstructed residual vector. When creating a reconstructed residual vector which has been initially created using the correct class centroid (i.e. for a bass class), the similarity between the two is much greater. This provides the power to discriminate between a correct and incorrect class assignment.

Following the calculation of the similarity, the method proceeds by determining, at operation S814, whether there are any further class prototypes for which a residual vector is to be created. This methodology is followed until a residual vector has been created and reconstructed for every prototype in the set of available class prototypes. If it is determined that there are further available class prototypes, the method returns to operation S806 to select the next class prototype. The operations of subtracting, inputting, and computing are performed for the new class prototype. If it is determined that there are no remaining class prototypes, then the method proceeds to operation S816, where the class having the highest similarity score is output as the class classification for the image data. This may be done using any suitable technique, e.g. using an argmax function, for identifying the highest similarity score.

It is to be appreciated that in some instances of the methodology of FIG. 8A, the image data which is received may relate to a class within a domain which has not yet been encountered (i.e., the classification model may have yet to encounter image data belonging to that particular class). In such cases, it would be inappropriate for the generative model to classify the image data as a particular previously encountered class.

In some optional embodiments therefore, a modified version of the approach of FIG. 8A may be introduced in which such an occurrence may be prevented. FIG. 8B shows an example of this modification. The modified approach begins following operation S814 of FIG. 8A in the instance where it is determined that there are no further class prototypes for which a reconstructed residual vector is to be determined (i.e., similarities have been determined between a reconstructed residual vector and a calculated residual vector for all available class prototypes). At this point, it is then determined, at operation S820, whether the similarity of the reconstructed residual vector and a calculated residual vector is above a threshold for one or more of the classes for which the vectors have been calculated. This may comprise for each class, determining a similarity score when determining the similarity of the reconstructed residual vector and a calculated residual vector, and comparing this with a threshold score. The threshold score may be a predetermined or user determined score which represents a minimum level of similarity that must be achieved in order for a class to be assigned to the received image data.

Where the similarity is above the threshold for at least one of the available classes, the methodology returns to operation S816 of FIG. 8A (i.e. by outputting the class with the highest similarity). Where the similarity is not above the threshold for at least one of the available classes, the approach continues by requesting, at operation S822, a user class input label in an approach analogous to operation S604 of FIG. 6. Following this request, a class label is received from the user at operation S824. Since a feature vector for the image data has already been calculated at operation S802, this can simply now be associated with the received label and stored as the class prototype for that newly labelled class (analogous to operation S610 of FIG. 6). This class prototype can then be utilised when classifying newly received image data.

FIG. 8B also shows an optional operation which could be incorporated in the method of FIG. 8A. Once the classification has been determined, at operation S830, the classification could be used to output an instruction to control the user device or to make a recommendation for such control. Examples of such control include a smart fridge using the classification to recognise when items are running low in the fridge and may thus output a recommendation to order more food or even automatically control a device to place an order. As an example, the method may enable a robot vacuum cleaner to detect/classify user items/pets and avoid them while cleaning (e.g. because some pets are scared). As another example, a smart oven may be able to recognise new cuisines/dishes inserted by the user and may recommend/initiate a correct cooking program. As an example, a smart washing machine may be able to recognise new clothes inserted by the user and may recommend/initiate a correct washing cycle. In other words, the user device may be controlled directly by the classification, e.g. to control movement of a device (e.g. a vacuum cleaner) or to control settings on a device (e.g. a washing machine, oven).

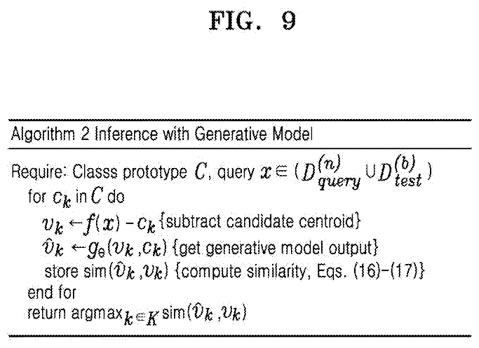

FIG. 9 is an example pseudocode showing an algorithm for an example algorithm used in inference. The inference process may be performed based on a set of class prototypes [symbol] and a query image x whose class is to be predicted. For each class prototype cₖ, a feature vector may be obtained from the query image using the backbone model. The residual vector vₖ is determined by subtracting the the class prototype cₖ from the feature vector f(x) of the query image x. The generative model g_{θ} may receive the residual vector together with the corresponding class prototype as input. The generative model g_{θ} may produce a predicted residual vector \hat{v}ₖ. Subsequently, a similarity score is calculated between the predicted residual vector and the original residual vector. This process is repeated for all available class prototypes. After similarity scores have been obtained for every class, the class that yields the highest similarity score is selected as the final classification result for the query image.

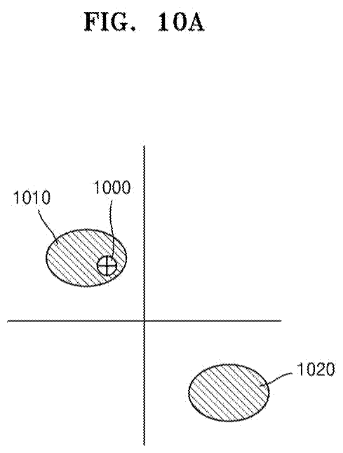

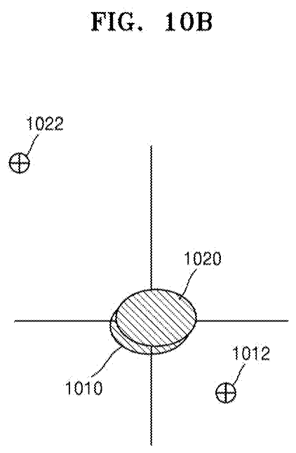

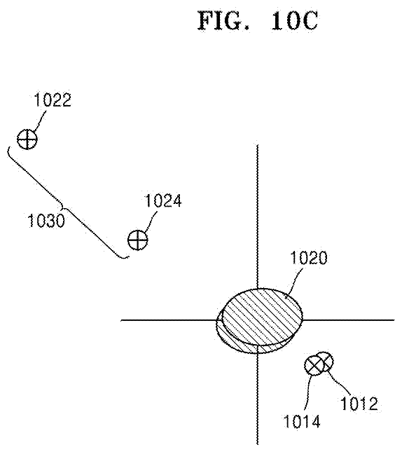

FIGS. 10A to 10C illustrates schematically why the vector is predicted from the class centre. FIG. 10A shows a feature space for the original embedding distributions. For simplicity, just two class distributions are shown: a first class distribution 1010 which is a base class generated as described in relation to FIG. 3 and a second class distribution 1020 which is a novel class generated as described in relation to FIG. 6. A feature vector which has been calculated from image data to be classified is shown at point 1000. This point 1000 to classify falls within the base class manifold and is far away from the novel class manifold. Moreover, the second class is very out of distribution because when it was generated by the classification model, the model had no knowledge of its data manifold and thus the second class distribution is centred around a prototype vector which is generated from a single result within the class. Hence, the novel class prototype vector is unlikely to be at the true centroid for all feature vectors which would fall within this class. This results in poor performance and makes it hard to reason.

As shown in FIG. 10B, the generative model learns only one manifold due to centring. In other words, the manifolds for the base and novel classes 1010 and 1020 overlap in the distribution of the feature space for the generative model. This is achieved by subtracting the class centre from each feature vector for the image to be classified to obtain a target point for each class which is the residual vector. The base class residual vector 1012 (target point) is the vector from the bass class prototype to the point to be classified. This prior is then forward propagated into novel classes and the novel class target residual vector 1022 is the vector from the novel class prototype to the point to be classified. The calculation of the residual vector helps generalisation in 1-shot.

Finally, as schematically illustrated in FIG. 10C, the proposed generative model generates a predicted/reconstructed novel class residual vector 1024 as well as a predicted/reconstructed base class residual vector 1014. The generative model has only seen distribution data that lies on the class manifold. Thus, for both the base and novel classes, the generative model reconstructs the residual vector as though the residual vector lies on the manifold of the candidate class. For the correct class (in this example—the base class), this should mean the predicted residual vector has an accurate prediction and the error is low, as evidenced by the small distance between the calculated and predicted residual vectors. For incorrect classes (in this example—the novel class), the generative model will predict a residual vector with a large error 1030, as evidenced by the large distance between the calculated and predicted residual vectors for the novel class. The generative model has effectively “pulled” the target point for each class.

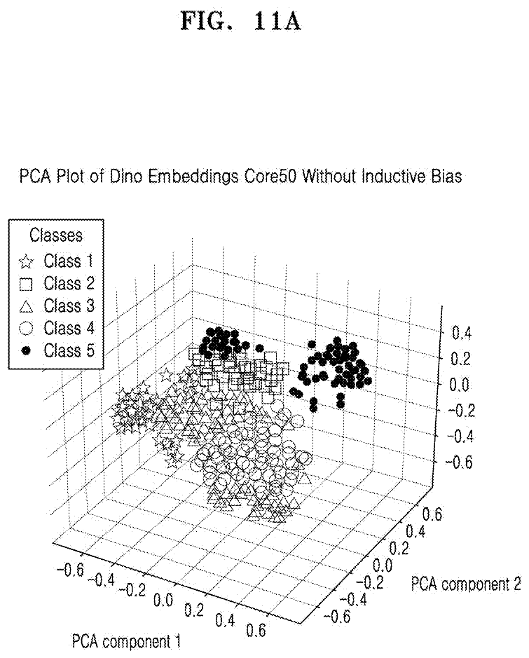

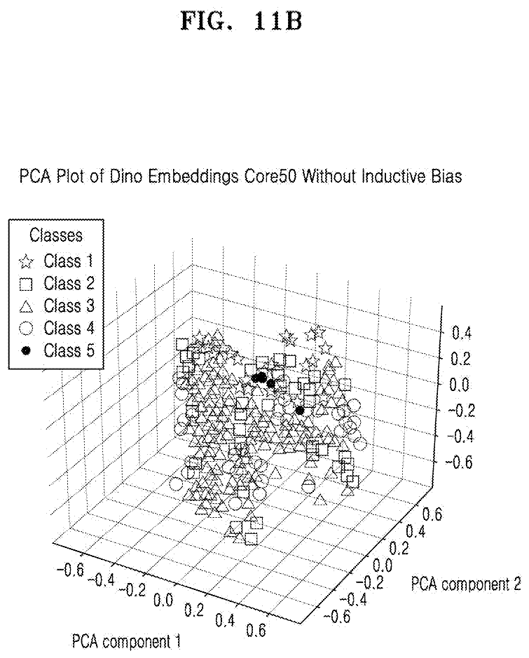

FIGS. 11A and 11B show the embeddings from an example feature embedding base mode, e.g. DINO-s model. These FIGS. 11A and 11B support the assumption which is used in the proposed techniques that class-wise embedding distributions are similar for a well-trained model. FIG. 11A shows five example class embeddings from a Dino-s model. The embedding clouds are similar in shape across the five classes. FIG. 11B shows the same five class embeddings but when the class mean is subtracted from each point (i.e. without inductive bias).

### Available Generative Models

Two main types of generative models are described in detail—variational autoencoders and diffusion models:

### Variational AutoEncoder

Variational AutoEncoders (VAEs) are a class of generative models that learn to maximise the likelihood p(x) of all observed data x. As an example, VAEs are described in “Auto-encoding variational bayes” by Kingma et al published in arXiv in 2013. VAEs assume that the data x is generated by some latent variable z and they are comprised of two distinct-yet-coupled models: an encoder and decoder. The encoder learns some distribution of latent variables conditioned on the observed data q_{φ}(z|x), and the decoder learns the distribution of the observed data over the latent variables p_{θ}(x|z).

Since directly computing the likelihood is intractable, VAEs instead maximise the Evidence Lower Bound (ELBO), given in the equation below.

$$log p ( x ) \geq {𝔼}_{{q}_{ϕ} ( z \vert x )} [ log \frac{{p}_{θ} ( x \vert z ) p ( z )}{{q}_{ϕ} ( z \vert x )} ] = {𝔼}_{{q}_{ϕ} ( z \vert x )} [ log {p}_{θ} ( x \vert z ) ] + {𝔼}_{{q}_{ϕ} ( z \vert x )} [ log \frac{p ( z )}{{q}_{ϕ} ( z \vert x )} ] = {\underbrace{{𝔼}_{{q}_{ϕ} ( z \vert x )} [ log {p}_{θ} ( x \vert z ) ]}}_{reconstruction loss} - {\underbrace{{𝒟}_{KL} ( {q}_{ϕ} ( z \vert x ) \vert \vert p ( z ) )}}_{prior matching term}$$

Here, q_{φ}(z|x) is the encoder, which is an approximate variational distribution parameterised by φ. The decoder is p_{θ}(x|z), parameterized by θ. Thus, at operation S414 of FIG. 4, the loss which is computed and backpropagated to train the generative model in the form of a VAE comprises a reconstruction loss and a prior matching term.

Note that it is possible to learn distributions conditioned on auxiliary information by providing context, y (e.g., a one-shot label), to the encoder and decoder thereby yielding q_{φ}(+(z|y,x) and p_{θ}(x|y, z). This is described for example in “Semi-supervised learning with deep generative models by Kingma et al published in Advances in neural information processing systems in 2014. In other words, adapting the equation above, the loss to train the VAE may be expressed as:

$${ℒ}_{vae} = {\underbrace{{𝔼}_{{q}_{ϕ} ( z \vert y , x )} [ log {p}_{θ} ( x \vert y , z ) ]}}_{reconstruction loss} - {\underbrace{{𝒟}_{KL} ( {q}_{ϕ} ( z \vert y , x ) \vert \vert p ( z ) )}}_{prior matching term}$$

VAEs can be generalised to hierarchical VAEs as described for example in “Improved variational inference with inverse autoregressive flow” by Kingma et al. published in Advances in neural information processing systems in 2016. Here, latents are generated from other latents. In other words, encoders can be stacked to generate a series of latents, and decoders can be stacked to reverse this process. Concretely, encoders and decoders become:

$${q}_{ϕ} ( {z}_{1 : T} ) = {q}_{ϕ} ( {z}_{1} \vert x ) {\prod }_{t = 2}^{T} {q}_{ϕ} ( {z}_{t} \vert {z}_{t - 1} )$$

$$p ( x , {z}_{1 : T} ) = p ( {z}_{T} ) {p}_{θ} {\prod }_{t = 2}^{T} {p}_{θ} ( {z}_{t - 1} \vert {z}_{t} )$$

The generative model is trained in the same way as above (i.e. at operation S414 of FIG. 4) using the ELBO, which may be extended to:

$$log p ( x ) \geq {𝔼}_{{q}_{ϕ} ( {z}_{1 : T} \vert x )} [ log \frac{p ( x , {z}_{1 : T} )}{{q}_{ϕ} ( {z}_{1 : T} \vert x )} ] \geq {𝔼}_{{q}_{ϕ} ( {z}_{1 : T} \vert x )} [ log \frac{p ( {z}_{T} ) {p}_{θ} ( x \vert {z}_{1} ) {\prod }_{t = 2}^{T} {p}_{θ} ( {z}_{t - 1} \vert {z}_{t} )}{{q}_{ϕ} ( {z}_{1} \vert x ) {\prod }_{t = 2}^{T} {q}_{ϕ} ( {z}_{t} \vert {z}_{t - 1} )} ]$$

During inference in standard FSCIL methods, a query sample x^{q} is typically assigned to the class whose prototype is closest in feature space according to some metric such as cosine or Euclidean distance. In the “RelationNet” approach described for example in “Learning to compare: Relation network for few-shot learning” by Sung et al. published in CVPR in 2018, the classifier head takes as input the query embedding, z_{q}, and a candidate prototype, cᵢ. The classifier makes a prediction over all prototypes, and the prototype for which the highest similarity score is output is assigned as the predicted class.

For the present method, a similar setup to the “RelationNet” approach is followed during the inference shown in FIG. 8A. For each candidate prototype, the corresponding direction vector v_{c} is calculated as explained in operation S808. Then, for a VAE at operation S816, the positive class which is output is that which has the largest lower bound on the log likelihood defined by:

$$\hat{y} = arg {max}_{c ∈ C} - {E}_{{q}_{ϕ} ( z \vert v )} [ log {p}_{θ} ( v \vert z ) ] - {𝒟}_{KL} [ {q}_{ϕ} ( z \vert v ) \vert \vert p ( z ) ]$$

Thus, an argmax function is used to output the class using the reconstruction loss and a prior matching term as described above.

### Diffusion Model

Diffusion models are generative models that learn to map a Gaussian distribution to a desired distribution as described for example in “Denoising diffusion probabilistic models” by Ho et al published in NeurIPS in 2020. As described for example in “Understanding diffusion models: Aunified perspective” by Luo et al published in srXiv in 2022, one may interpret a Diffusion Model as simply a Markovian Hierarchical Variational Autoencoder with three key restrictions:
The dimensions of the data and the latent space are equal;
Instead of being learnt, the encoders are predefined as linear Gaussian models;
The Gaussian parameters of the encoders vary over time such that at the final timestep T, the latent distribution is Gaussian;
The encoder simply adds Gaussian noise to the sample:

$$q ( {x}_{1 : T} \vert {x}_{0} ) := {\prod }_{t = 1}^{T} q ( {x}_{t} \vert {x}_{t - 1} ) ,$$

where: q(xₜ|xₜ₋₁):= [symbol] (xₜ;\sqrt{1−βₜ}xₜ₋₁,βₜ)
The decoder is then defined as:

$${p}_{θ} ( {x}_{0} : T ) := p ( {x}_{T} ) {\prod }_{t = 1}^{T} {p}_{θ} ( {x}_{t - 1} \vert {x}_{t} )$$

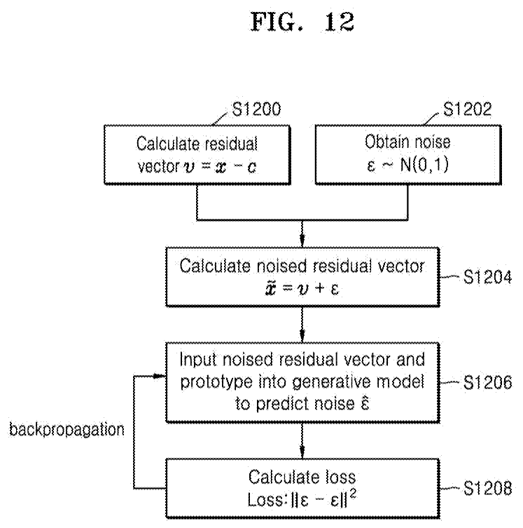

FIG. 12 is an alternative representation of the pipeline for training a generative model which is a diffusion model. FIG. 12 shows a specific implementation of the techniques described above which are implemented on the server. This server-side training phase is unseen by the users. FIG. 12 shows more detail of the training loop of operations S412 to S418 of FIG. 4. At operation S1200, the residual vector is calculated for each base class as described in detail. In other words:

$$v = x - c$$

where v is the residual vector, c is the class prototype and x is the feature vector for the input image.

At operation S1202, noise is obtained, for example from a Gaussian distribution, e.g. ε~N(0,1). During training, the image is corrupted with the noise. At operation S1204, the noised residual vector \tilde{x} is calculated using:

$$\tilde{x} = v + ε$$

The noised residual vector \tilde{x} and protoype c used to generate this noise residual vector is then input into the decoder of generative model to generate a prediction of the noise t which was used to generate the noise residual vector as shown at operation S1206. then the decoder is trained to predict this noise by calculating a loss at operation S1208 between the predicted noise and the noise used to calculate the noised vector, e.g.:

$${ℒ}_{D D P M} = {𝔼}_{\tilde{x} , τ} {‖ ϵ - {ϵ}_{θ} ( \tilde{x} , τ ) ‖}_{2}^{2}$$

where \tilde{x} is the noised sample and τ is the denoising timestep. The loss is backpropagated and the parameters of the decoder are adjusted to minimise the loss. These operations are repeated for all the training data.

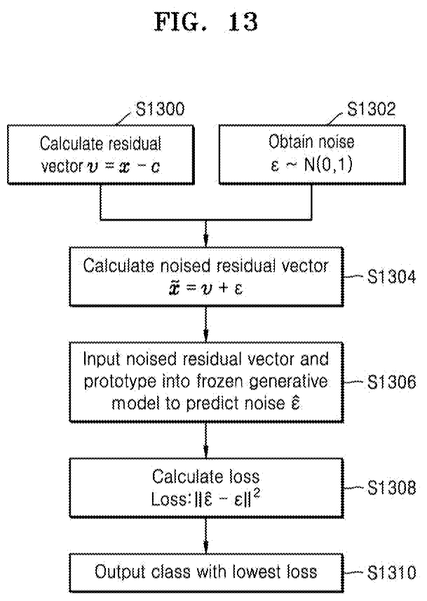

FIG. 13 shows a specific implementation of the techniques described above which are implemented on the device side. This on-device phase is the process which is seen by the users. The proposed techniques use generative feature modelling. FIG. 13 shows more detail of the inference loop of operations S808 to S816 of FIG. 8A. For an input image, a feature vector is calculated using the frozen backbone ML model and all possible class prototypes for base and novel classes are obtained. At operation S1300, the residual vector is calculated for each class as described in detail above. In other words:

$$v = x - c$$

where v is the residual vector, c is the class prototype and x is the feature vector for the input image.

At operation S1302 (as in operation S1202), noise is obtained for example from a Gaussian distribution, e.g. ε~N(0,1). At operation S1304, the noised residual vector z is calculated by the encoder as in the training operation using:

$$\tilde{x} = v + ε$$

The noised residual vectors and protoype c used to generate this noise residual vector is then input into the decoder of generative model to generate a prediction of the noise \tilde{ε} which was used to generate the noise residual vector as shown at operation S1306. A loss for the predicted noise is calculated at operation S1308. The loss is the loss between the predicted noise and the noise used to calculate the noised vector. Finally, at operation S1310, the class having the lowest loss value is then output. Thus as for a diffusion model the class which generates the largest similarity between g_{θ}(v,cᵢ) and v (e.g., minimises the denoising error) is output and this may be calculated using:

$$\hat{y} = arg {max}_{c ∈ 𝒞} - {𝔼}_{\tilde{v} , τ} {‖ ϵ - {ϵ}_{θ} ( \tilde{v} , c , τ ) ‖}_{2}^{2}$$

Focus is centred on denoising the class-centred points. In other words, the noise added to the vector from the class centroid is predicted. The generative diffusion model learns to project the noised vectors onto the class surface, thus learning geometric structure of class point cloud. If this structure is similar for base and novel classes, then this knowledge is transferred to novel classes, and the diffusion model will work very well on one-shot classification tasks. The generative model has much higher awareness of signal vs noise in feature space, thus improving robustness of the classification to the image noise. Thus, knowledge about class structure can be forward propagated to novel classes, giving strong 1-shot capability.

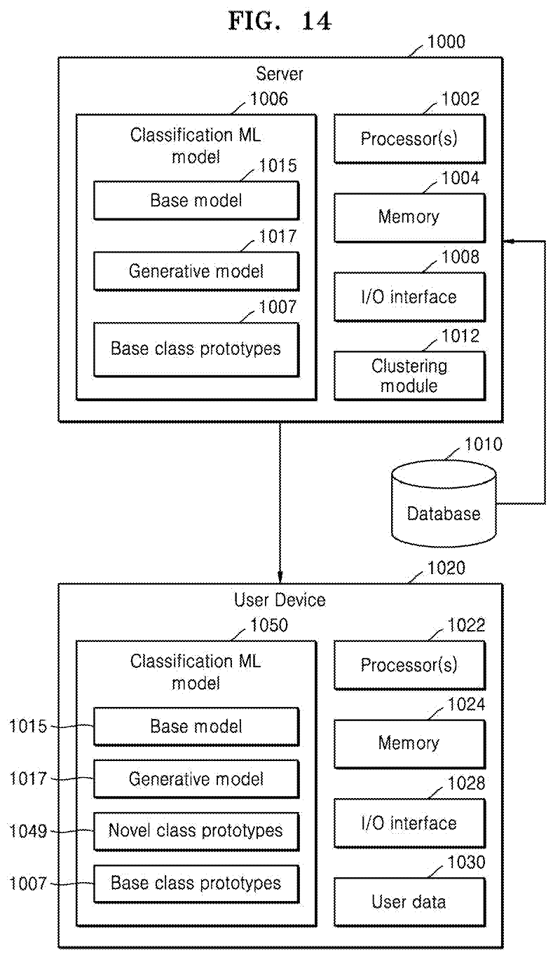

FIG. 14 illustrates an example system which may be used to implement the new techniques described above. The system comprises a server 1000 which may be a single server or collection of servers (e.g. the cloud). The server 1000 comprises at least one processor 1002 coupled to memory 1004. The memory 1004 may store instructions. The at least one processor 1002 may comprise one or more of: a microprocessor, a microcontroller, and an integrated circuit. The at least one processor 1002 included in the processor may include processing circuitry. The at least one processor 1002 included in the processor may execute instructions stored in the memory, individually or collectively. The at least one processor 1002 may include one or more central processing units (CPUs) and/or one or more graphics processing units (GPUs). The memory 1004 may comprise volatile memory, such as random-access memory (RAM), for use as temporary memory, and/or non-volatile memory such as Flash, read only memory (ROM), or electrically erasable programmable ROM (EEPROM), for storing data, programs, or instructions, for example.

A classification model 1006 may be stored on the server 1000, e.g. during the training described above. The classification model 1006 may comprise a base model (ML model) 1015, e.g. a vision ML model which is used to generate feature vectors from images and a generative model 1017. The generative model (ML model) 1017 may be a model configured to generate reconstructed residual vectors between a feature vector and its class centroid in accordance with embodiments described above. The server 1000 also comprises an input/output interface 1008 (or similar communication module) which connects the device to a database 1010. The database 1010 may comprise training dataset(s) for training the ML model. The database 1010 may also comprise additional ML models from which the base ML model or the generative model may be selected as described above. The server may comprise a clustering module 1012 for generating the prototypes for the base classification dataset which may also be termed a set of base class prototypes 1007. The base classification dataset may be stored on the server 1000. The server 1000 is also coupled to at least one apparatus/user device 1020.

The user device 1020 also comprises similar standard components to the server 1000. The user device 1020 comprises at least one processor 1022 coupled to memory 1024. The memory 1024 may store instructions. The at least one processor 1022 may comprise one or more of: a microprocessor, a microcontroller, and an integrated circuit. The at least one processor 1022 included in the processor may include processing circuitry. The at least one processor 1022 included in the processor may execute instructions stored in the memory, individually or collectively. The at least one processor 1022 may include one or more central processing units (CPUs) and/or one or more graphics processing units (GPUs). The memory 1024 may comprise volatile memory, such as random-access memory (RAM), for use as temporary memory, and/or non-volatile memory such as Flash, read only memory (ROM), or electrically erasable programmable ROM (EEPROM), for storing data, programs, or instructions, for example. The classification model (ML model) 1050 comprising both the trained base model 1015 and the trained generative model 1017 is stored on the electronic device 1020 together with the base class prototypes 1007 (typically used to train the base model 1015) and the user-specific classification dataset which comprises the novel class prototypes 1049. The user-specific classification dataset will typically comprise novel class prototypes for classes provided by the user that the underlying classification model (ML model) was not trained on, in accordance with embodiments described above. User data 1030 which is used to personalize the model, e.g. to create the user-specific classification dataset may be stored on the user device and for security reasons may not leave the user device. There is also an input/output interface 1028 which connects the user device 1020 to the server 1000.

### Experimental Setup

Datasets and Models—This method is evaluated in the 1-shot setting, on both a DinoV2-S and a ResNet18 backbone. Dino is evaluated on both the Core50 dataset (described in “Core50: a new dataset and benchmark for continuous object recognition” by Lomonaco et al published in arXiv in 2017 and the iCubWorld dataset “described in “icub world: Friendly robots help building good vision data-sets” by Fanello et al published in Proceedings of the IEEE Conference on Computer Vision and Pattern Recognition Workshops in 2013 with 25 base classes and 25 novel classes. Dinov2 is a foundation model pretrained on a huge amount of data. This gives it a structured latent space that is well suited to FSCIL. Since Dinov2 is trained on many common datasets (e.g. imagenet, cifar, cub), generalization on unseen datasets is evaluated, like CORE50 and iCubWorld:

| Dataset | Num Images | Num Base Classes | Num Novel Classes |
|---|---|---|---|
| CORE50 | 164,866 | 25 | 25 |
| iCubWorld | 7629 | 25 | 25 |

ResNet18 is evaluated on the CUB200 dataset (described in “The caltech-ucsd birds-200-2011 dataset” by Wah et al published in 2011) and the Cifarl00 dataset (described in “Learning multiple layers of features from tiny images” by Krizhevsky et al. published in 2009. There are 160 base classes and 60 base classes, respectively, and 40 novel classes for each. Here, a ResNet18 backbone pretrained on imagenet is taken. Since this model is weaker, for ProtoNet finetuning over the base classes using ProtNet loss is performed. This finetuned backbone is taken as the embedding model for this method. Other baselines also update the backbone. The datasets are summarised as:

| Dataset | Num Images | Num Base Classes | Num Novel Classes |
|---|---|---|---|
| CUB200 | 11,788 | 160 | 40 |
| Cifar100 | 60,000 | 60 | 40 |

Additional evaluations are conducted relating to the performance of the present approach when only a single novel class is present.

Approaches—Comparison is made to a range of methods that employ a base training mechanism that could be useful downstream. The methods which are compared include ProtoNet which is described in “Prototypical networks for few-short learning” by Snell et al published in Advances in neural information processing systems and the state-of-the-art in 2017; RelationNet described for example in “Learning to compare: Relation network for few-shot learning” by Sung et al. published in CVPR in 2018; FACT described for example in “Forward compatible few-shot class-incremental learning” by Zhou et al published in CVPR in 2022; LIMIT described in “Few-shot class-incremental learning by sampling multi-phase tasks” by Zhou et al published in “IEEE Transactions on Pattern Analysis and Machine Intelligence 2023”; SAVC described for example in “Semantic-aware knowledge distillation for few-shot class incremental learning” by Song et al published in Proceedings of the IEEE/CVF conference on computer vision and pattern recognition in 2023; and OrCO described for example in “OrCO: Towards better generalization via orthogonality and contrast for few-shot class-incremental learning” by Ahmed et al published in CVPR in 2024.

Comparison methods are selected that do not overly rely on incremental training adjustments, since these are inapplicable to the 1-shot scenario. Other than RelationNet, benchmark methods focus on creating good separation of the base classes in the embedding space. RelationNet introduces an output head that predicts similarity between a prototype and a query sample. Finally, for ProtoNet, RelationNet, and the proposed method on Dino the backbone is not updated, i.e. the backbone is frozen. For the former the nearest class mean classifier is employed, and for the latter two methods only the output head/generative classifier is trained. For ResNet18, this method is deployed on top of the backbone trained with Prototypical Loss.

For all methods: base classes are learnt via episodic training; base Prototypes are calculated via training set as the mean embedding and novel classes are presented with 1 exemplar. Methods are not permitted to train over this sample. For the proposed method: a pretrained embedding model (e.g., DinoV2 or ResNet) is taken; a generative model is trained over these outputs and reconstruction loss is minimised over only positive samples.

Metrics—For metrics, the base and novel class accuracy is evaluated, as well as reporting the average accuracy which is the mean of the two.

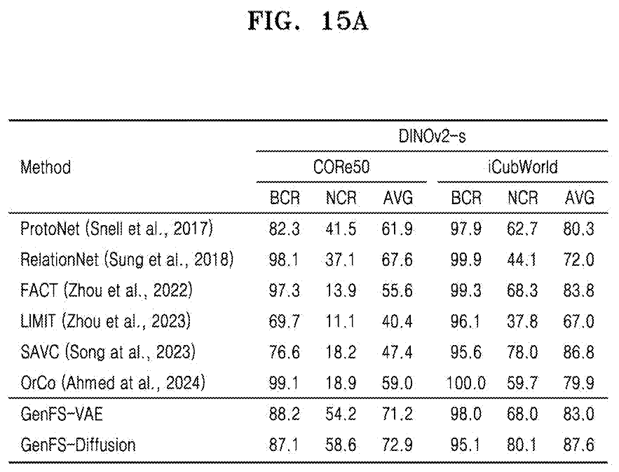

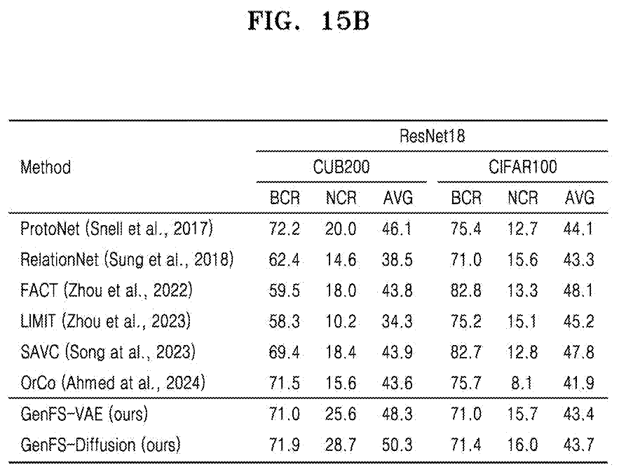

Experiments—The results for both embedding models where a plurality of novel classes are provided are shown in FIGS. 15A and 15B. The results show that the proposed method, paired with a diffusion model, achieves SOTA for novel class recognition across all datasets and models. This supports the hypothesis that there are valuable priors to be extracted from base classes for downstream learning. However, the relatively weaker performance of our method on ResNet18 compared to Dino suggests that Dino is a better generalized model with greater similarity in the class structure.

For three of the four datasets, the proposed method also achieves SOTA combined accuracy, demonstrating that the proposed method can support an acceptable level of base class accuracy while significantly improving the NCR. While the present method was more effective when paired with a diffusion model, for all datasets except for iCubWorld it was found that the VAE version was also better than every other method when evaluating NCR, suggesting that the method is robust and agnostic to choice of generative model.

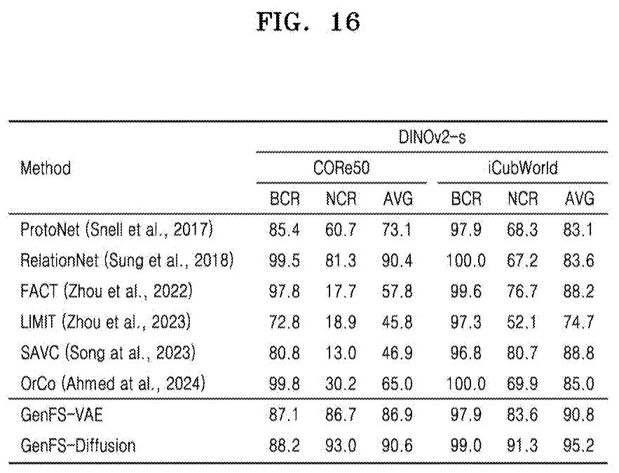

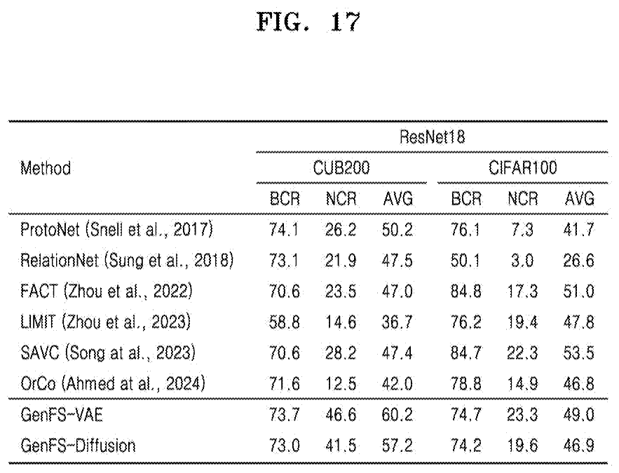

Additionally, and as illustrated in FIGS. 16 and 17, the proposed method also SOTA for novel class recognition where only a single novel class is provided.

### Further Experimental Setup

To evaluate the hypothesis that base classes provide informative priors for novel classes and that these priors are often not Gaussian, we compare the similarity of base class embedding distributions to a Gaussian that we fit over the base data through the formulation of an optimal transport problem. Specifically, for a set of base class embeddings Z_{b}={z_{b,1}, z_{b,2}, . . . , z_{b,n}} and a set of novel class embeddings Z_{f}={z_{f,1}, z_{f,2}, . . . , z_{f,n}}, we measure the minimum work required to move Z_{b} onto Z_{f} using the Wasserstein distance, defined as:

$$W ( A , B ) = \sqrt{{min}_{γ ∈ Γ} {\sum }_{i = 1}^{n} {\sum }_{j = 1}^{n} {γ}_{i , j} {‖ {z}_{b , i} - {z}_{f , j} ‖}^{2}}$$

where Γ is the set of valid transport plans (γ_{i,j}≥0,∀i,j) ensuring uniform mass distribution across all points.

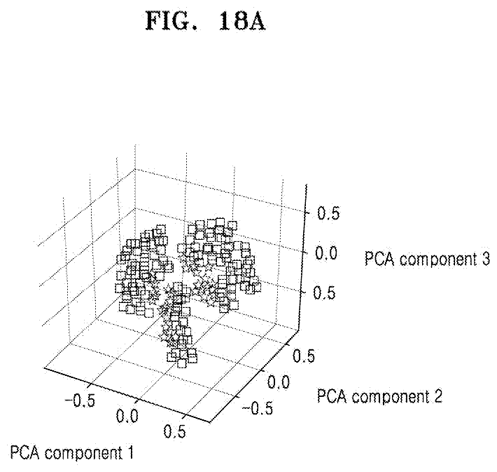

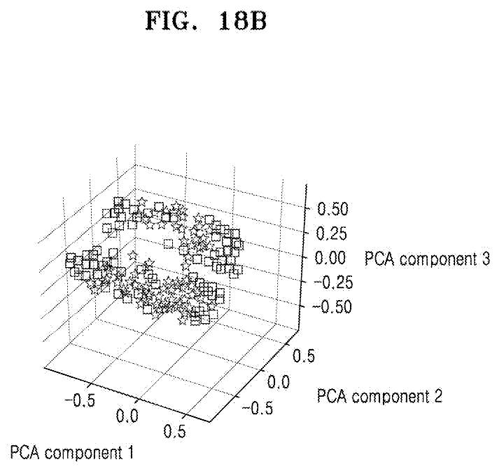

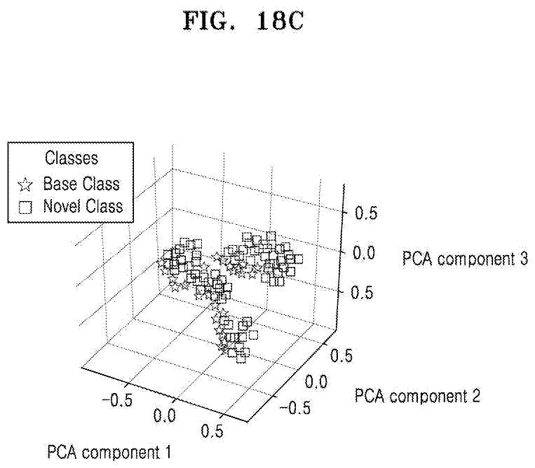

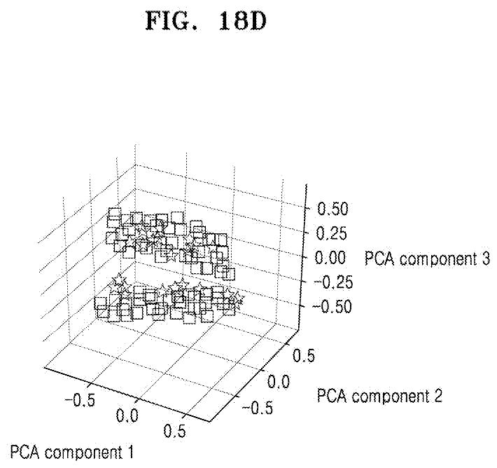

FIGS. 18A to 18D each present a PCA projection for one of four novel class embeddings alongside a base class with similar structural properties. The plot reveals that these distributions are often multi-modal and rarely Gaussian, highlighting a key challenge for prototype-based FSCIL methods which struggle to generalize in such scenarios. Additionally, qualitatively it is appreciated that base and novel classes exhibit similar embedding structures.

To quantify this, the average Wasserstein distance is computed between novel class embeddings and both base class embeddings and a Gaussian distribution fitted to the base data via maximum likelihood estimation. The table below shows these results:

| | | Base | Gauss | Base v Gauss |
|---|---|---|---|---|
| Model | Dataset | (↓) | (↓) | (↑) |
| DINOv2-s | CORe50 | 0.03 | 0.08 | 100% |
| DINOv2-s | iCubWorld | 0.04 | 0.07 | 100% |
| ResNet18 | CUB200 | 0.02 | 0.08 | 100% |
| ResNet18 | CIFAR100 | 0.02 | 0.08 | 97.5% |

The table shows that ≥97.5% of times there exists a base class significantly more similar to a novel class than the to the Gaussian model. These findings reinforce the idea that base classes provide rich, informative priors beyond simple Gaussian assumptions, supporting the methodology proposed herein.

### Comparison to Distance Based Models

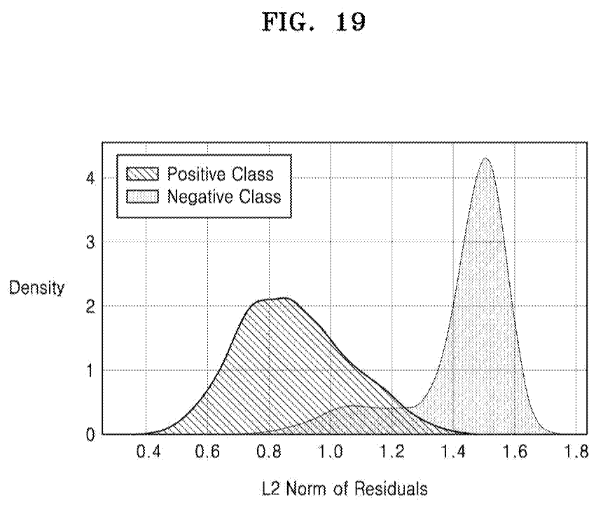

FIG. 19 shows the distribution of residuals from a sample to correct (positive) and incorrect (negative) class prototypes. Two key observations arise:

1. Closer Positive Residuals: The average distance of a sample to its positive class prototype is closer than its distance to any negative class prototype. This indicated that residuals can effectively distinguish between classes, as utilized in the methodologies described herein.

2. SignificantResidual Overlap: Despite the above, there is considerable overlap between the residual distributions of positive and negative classes. This complexity poses significant challenges for methods that rely solely on simple distance metrics, such as Euclidean distance or cosine similarity, to determine class membership.

In summary, one-shot class-incremental learning is a challenging and unsolved task. In this work, a novel solution to the problem has been presented, based on learning generative priors over the base classes to be used downstream on novel classes. The proposed method is agnostic to the generative model type, although diffusion modeling proved to be the most effective. The proposed approach learns the centered class densities for all classes without expanding the model size, or updating model parameters as new classes are introduced.

SOTA is achieved in all benchmarks for novel class accuracy, and achieve SOTA in three of four benchmarks for overall accuracy, suggesting the proposed method is a robust and effective solution. Existing methods are improved upon by as much as 17 percentage points on core50. For both datasets, the proposed method achieves the highest combined accuracy averaged over both base and novel classes. This is achieved as a result of the informative prior over the class structure.

In summary, the proposed method constructs a prior over the base classes about the structure of the class-wise distribution of learned embeddings, using a generative model (e.g., a diffusion model or a variational autoencoder model), which is then used to guess the feature distribution of novel classes to facilitate one-shot classification without training. The contributions described herein include the first to FSCIL method that leverages generative priors for single-shot generalisation, yielding superior novel class recognition with minimal forgetting of the base classes. The use of diffusion classifiers for FSCIL is novel. It is shown that this method can achieve SOTA performance in single-shot CIL tasks. Traditional prototype-based methods and MSE-based methods assume simple intra-class distributions, such as uni-modal Gaussians. Critically, the proposed approach makes no such assumptions and can handle arbitrarily complex, multi-modal distributions.

The table below shows a conceptual comparison to the prior art. In summary, in exchange for increased model complexity, significant gains in novel class accuracy can be achieved while preserving base class accuracy:

| | | Model | Model |
|---|---|---|---|
| | | Accuracy on | Accuracy on |
| Metric/technique | Model Complexity | base classes | novel classes |
| Standard | Lowest | Highest | Null |
| supervised learning | | | |
| Finetuning | Highest. Need to | Medium-high | Very low |
| | support training ops. | | |
| FSL prototype | Low | High | Medium low |
| based | | | |
| RelationNet | Medium, extra | High | Medium-low |
| | output head | | |
| Advanced | Low | Highest | Low |
| Prototype FSL | | | |
| (SAVC, etc) | | | |
| Proposed | Medium, denoising | High | Highest |
| techniques | inference head | | |
| Target for on- | Low-Medium | High-Highest | High |
| device deployment | | | |

There appears to be no significant overlap between the prior art methods and the proposed system. In particular, there appears to be no teaching of explicitly exploiting class structure for few shot class incremental learning. No prior art appears to leverage diffusion models as a classifier head for few shot class incremental learning. No prior art leverages diffusion models to generate synthetic class data in feature space. No prior art can find good tradeoffs for 1 labelled sample.

### Use Cases

There are a variety of use cases for the techniques described above. These include a class-incremental recipe recognition for a smart oven, a class-incremental recipe recognition for a smart fridge, use on a smartphone, e.g. as part of the camera and gallery app, and a class-incremental programme recognition for a washing machine. In each of these cases, the above techniques may be utilised in a variety of appliances in which object recognition is provided in order to make suggestions to a user relating to those items.

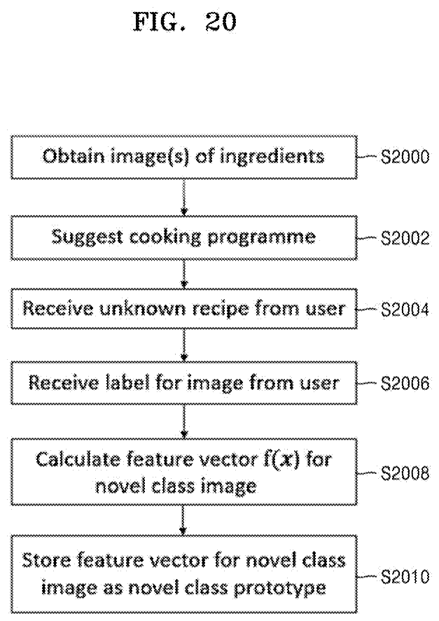

For instance in the scenario of a smart oven shown in FIG. 20, at operation S2000, the oven obtains images of ingredients and classifies the images to suggest a cooking programme at operation S2002. The user chooses to reject the suggestion and insert a different unknown recipe at operation S2004. This means that the recognition of the images and output of the recipe has failed in this instance. To prevent further similar failures, at operation S2006, a label for the image(s) obtained at operation S2000 is obtained—this could be the new recipe inserted at operation S2004. The method described above is then used to generate a new feature vector or new class prototype for the novel class image at operation S2008 and this feature vector is stored at operation S2010. Next time the image(s) which were received at operation S2000 are received again, the novel recipe will be output. There is no need to update the parameters of the backbone model or the generative model to improve the performance for the next time.

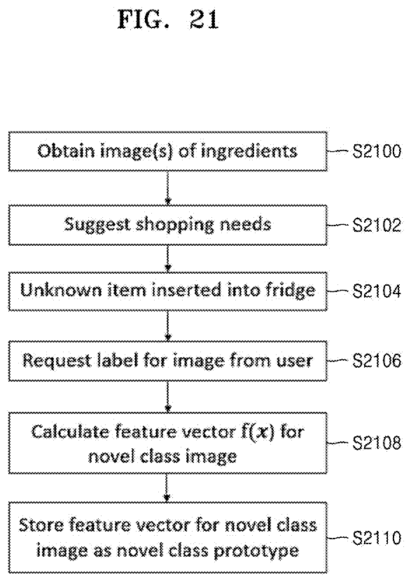

For instance, in the scenario of a smart fridge (as illustrated in FIG. 21), the appliance may be configured to identify food items within it as shown at operation S2100 in order to determine recipes which may be made with these items and where items are missing, may suggest these items for purchase as shown at operation S2102. However, in instances where objects are placed in the appliance belonging to an unknown class as shown at operation S2104, the application fails and as such the object cannot be used for the purposes of recipe or shopping determination. Using the above techniques, the user can, in response to a request for a label at operation S2106, simply input the name of the unrecognised object once, and the appliance will subsequently be able to identify this object for the utility described above. In other words, the method described above is then used to generate a new class prototype for the novel class image at operation S2108 and this is stored at operation S2110. Next time the item is missing/placed in the fridge, the correct shopping/recipe will be output.

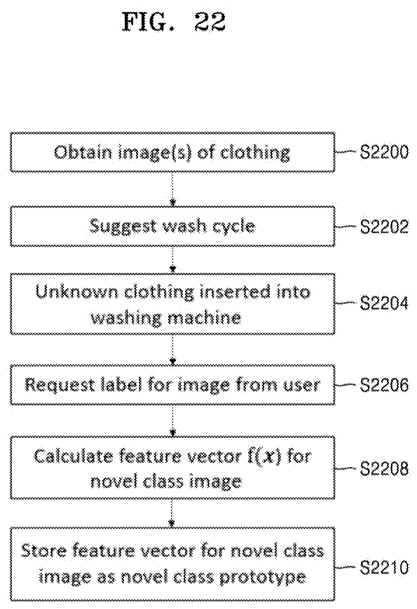

For instance, in the scenario of a smart washing machine (as illustrated in FIG. 22), the appliance may be configured to identify clothing items within it as shown at operation S2200 in order to suggest the correct wash cycle (e.g. temperature, duration etc) as shown at operation S2202. However, in instances where objects are placed in the appliance belonging to an unknown class (e.g. after a user has bought new clothes) as shown at operation S2204, the application fails and as such the washing machine cannot make a recommendation. Using the above techniques, the user can, in response to a request for a label at operation S2206, simply input the name of the unrecognised object once, and the appliance will subsequently be able to identify this object for the utility described above. In other words, the method described above is then used to generate a new class prototype for the novel class image at operation S2208 and this is stored at operation S2210. Next time the item is missing/placed in the washing machine, the correct wash cycle will be output. In other words, the image classification is used to affect an output on the identified object within the image.

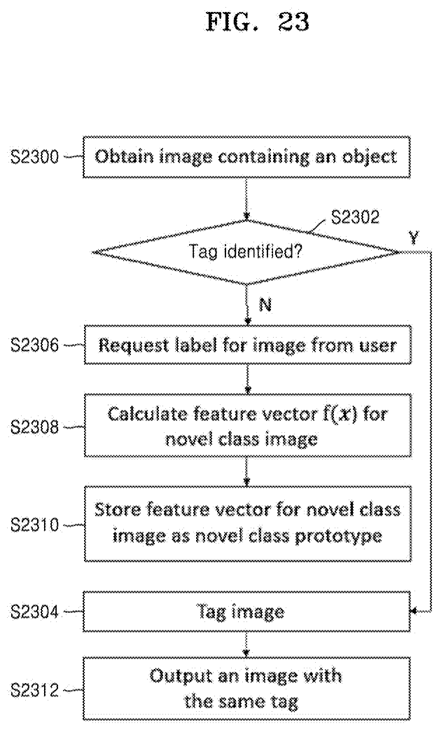

Other uses include subject-driven class-conditioned image generation on a smartphone or similar device. This may comprise enabling morphing a provided image which includes a particular object (e.g. cat) onto a surface of a separate class (e.g. dog) for the purposes of generating a new image. As an alternative use for images on a smartphone, FIG. 23 shows a gallery app which is automatically able to identify people and objects in images for faster retrieval/filtering in the gallery app. At operation S2300, an image containing at least one object or person is obtained, e.g. by a user taking a photo with the camera on the phone. At operation S2302, there is an operation to determine whether the object(s) within the photo can be tagged/identified. If they can be identified/classified, the image is tagged with the output classification(s) at operation S2304. Otherwise, the user can, in response to a request for a label at operation S2306, simply input the name/tag of the unrecognised object(s) once. The method described above is then used to generate a new class prototype for the novel class object at operation S2308 and this is stored at operation S2310. Next time, the object(s) within the image can be identified readily. For example, when a user requests an image with the tagged object, at operation S2312, the image with the tag will be output.

The method of FIG. 23 is also able to adapt to blurry images by requesting the label of an object/person within a blurry image and calculating and storing the feature vector as a 1-shot example for that label. In other words, the blurry image is processed as a new class and the classification model is able to quickly adapt to blurry images. Next time, the object(s) within the image can be identified readily. For example, when a user requests an image with the tagged object, the image with the tag will be output, even when the image is blurry.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

In an approach of the present techniques, there is provided a method of generating a classification machine learning, ML, model for deployment to a user device. The method includes obtaining a backbone ML feature embedding model for generating feature embedding vectors of images. The backbone ML feature embedding model is associated with a set of base classes. each base class in the set of base classes has a base class prototype which is a feature embedding vector which is representative of the base class. The method includes obtaining a training dataset comprising a plurality of input images each of which has a base class label from the set of base classes. The method includes generating, using multiple input images in the training dataset, training data for the generative ML model. The generating training data for the generative ML model includes, for each input image in the multiple input images, extracting, using the backbone ML model, an input feature embedding vector for the input image. The generating training data for the generative ML model includes, for each input image in the multiple input images, selecting the prototype feature embedding vector corresponding to the base class label for the input image. The generating training data for the generative ML model includes, for each input image in the multiple input images, calculating a residual vector comprising a distance and a direction between the extracted input feature embedding vector and the selected prototype feature embedding vector in a feature space which is defined by the input feature embedding vectors for the multiple input images. The generating training data for the generative ML model includes, for each input image in the multiple input images, associating the calculated residual vector with the selected prototype feature embedding vector as an instance of the training data for the generative ML model. The method includes training the generative ML model to generate a reconstructed residual vector using the training data comprising calculated residual vectors and associated prototype feature embedding vectors. The method includes outputting the classification ML model comprising the backbone ML model and the generative ML model to a user device.

The generating the training data for the ML model includes dividing the plurality of input images in the training dataset into a support set and a query set. The support set and the query set each contain one or more input images of each known base class. The multiple input images are the query set.

The selecting the prototype feature embedding vector corresponding to the base class label for the input image includes selecting the prototype feature embedding vector generated using a support set.

Prior to the generating the training data for the generative ML model, the method includes generating, using a support set, the prototype feature embedding vector for each base class by identifying each image in the support set which is labelled with the base class. Prior to the generating the training data for the generative ML model, the method includes generating, using a support set, the prototype feature embedding vector for each base class by extracting, using the backbone ML feature embedding model, a feature embedding vector for each identified input image. Prior to the generating the training data for the generative ML model, the method includes generating, using a support set, the prototype feature embedding vector for each base class by calculating a mean feature vector from the extracted feature embedding vectors, wherein the calculated mean feature vector is the prototype feature embedding vector.

The generative ML model is a variational autoencoder, VAE, comprising an encoder and a decoder. The training the generative ML model comprises calculating a reconstruction loss between the reconstructed residual vector and the residual vector. The training the generative ML model comprises adjusting the parameters of the VAE to minimise the calculated loss.

The method includes calculating an evidence lower bound loss which comprises a reconstruction loss and a prior matching term.

The generative ML model is a diffusion model comprising an encoder and a decoder. The training the generative ML model comprises applying, using the encoder, noise to the calculated residual vector. The training the generative ML model comprises generating, using the decoder, a prediction of the noise which was added. The training the generative ML model comprises calculating a loss between the predicted noise and the applied noise. The training the generative ML model comprises adjusting the parameters of the diffusion model to minimise the calculated loss.

The method includes outputting, to the user device, the set of base classes and base class prototype feature vectors when outputting the classification ML model.

The method includes extracting, using a backbone ML feature embedding model of the classification ML model, an input feature embedding vector for an input image comprising an object to be classified. The method includes, for each prototype feature embedding vector of the set of class prototypes, calculating a residual vector comprising a distance and a direction between the extracted input feature embedding vector and the prototype feature embedding vector. The method includes, for each prototype feature embedding vector of the set of class prototypes, inputting each calculated residual vector and associated prototype feature embedding vector into a generative ML model of the classification ML model to predict a reconstructed residual vector. The method includes, for each prototype feature embedding vector of the set of class prototypes, calculating a similarity score between each calculated residual vector and the predicted reconstructed residual vector. The method includes outputting a predicted class for the input image based on the calculated similarity score.

The method includes comparing each similarity score to a threshold similarity score. The method includes, when at least one similarity score is greater than or equal to the threshold, outputting the predicted class having a highest similarity score.

The method includes, when all similarity scores are lower than a threshold, prompting a user to provide a label for a new class for the input image comprising the object to be classified.

The method includes receiving user feedback that an output predicted class for the input image is inaccurate. The method includes prompting a user to provide a label for a new class for the input image comprising the object to be classified.

The method includes receiving an input image with a label for a new class. The method includes extracting using the backbone ML feature embedding model of the classification ML model, a feature embedding vector for the input image with the label for the new class. The method includes storing, in the set of class prototypes, the extracted feature embedding as a prototype feature embedding for the new class.

In an approach of the present techniques, there is provided a method of a personalised classification ML model for classifying an input image. The method includes receiving, at a user device, a classification ML model and a set of class prototypes, each of which is in the form of a prototype feature embedding vector which is representative of the class. The method includes at the user device, an input image and a label for a new class for the image, wherein the new class is a class for which there is no class prototype within the set of class prototypes. The method includes extracting, using a backbone ML feature embedding model of the classification ML model, a feature embedding vector of the input image. The method includes storing, in the set of class prototypes, the extracted feature embedding vector as a prototype feature embedding vector for the new class.

The method includes receiving, at the user device, an additional image comprising an object labelled with the new class for which a prototype feature embedding vector has already been generated. The method includes extracting, using the backbone ML feature embedding model of the classification ML model, a feature embedding vector for the additional image. The method includes calculating a mean of the prototype feature embedding vector and the extracted feature embedding vector to generate an updated prototype feature embedding vector for the new class. The method includes replacing the stored prototype feature embedding vector with the updated prototype feature embedding vector.

The outputting the predicted class includes modifying the input image to include the output predicted class. The outputting the predicted class includes outputting the modified image.

The method includes controlling the user device based on the output predicted class and/or outputting a recommendation based on the output predicted class.

What is claimed is:

1. A computer-implemented method of generating a classification machine learning (ML) model for deployment to a user device, the method comprising:
obtaining a backbone ML feature embedding model for generating feature embedding vectors for images, wherein the backbone ML feature embedding model is associated with a set of base classes and each base class in the set of base classes has a base class prototype in the form of a feature embedding vector which is representative of the base class;
obtaining a training dataset comprising a plurality of input images each of which has a label corresponding to a base class from the set of base classes;
obtaining a generative ML model;
generating, using multiple input images in the training dataset, training data for the generative ML model by:
for each input image in the multiple input images:
extracting, using the backbone ML feature embedding model, an input feature embedding vector for the input image;
selecting the prototype feature embedding vector corresponding to the base class label for the input image;
calculating a residual vector comprising a distance and a direction between the extracted input feature embedding vector and the selected prototype feature embedding vector in a feature space which is defined by input feature embedding vectors extracted for the multiple input images; and
associating the calculated residual vector with the selected prototype feature embedding vector as an instance of the training data for the generative ML model;
training, using the training data comprising calculated residual vectors and associated prototype feature embedding vectors, the generative ML model to generate a reconstructed residual vector; and
outputting the classification ML model, comprising the backbone ML feature embedding model and the trained generative ML model, to a user device.

2. The method of claim 1, wherein the generating the training data for the ML model comprises:
dividing the plurality of input images in the training dataset into a support set and a query set, wherein the support set and the query set each contain one or more input images of each known base class and wherein the multiple input images are the query set.

3. The method of claim 2, wherein the selecting the prototype feature embedding vector corresponding to the base class label for the input image comprises selecting the prototype feature embedding vector generated using a support set.

4. The method of claim 3, further comprising prior to the generating the training data for the generative ML model:
generating, using a support set, the prototype feature embedding vector for each base class by:
identifying each image in the support set which is labelled with the base class;
extracting, using the backbone ML feature embedding model, a feature embedding vector for each identified input image; and
calculating a mean feature vector from the extracted feature embedding vectors, wherein the calculated mean feature vector is the prototype feature embedding vector.

5. The method of claim 1,
wherein the generative ML model is a variational autoencoder (VAE) comprising an encoder and a decoder, and
wherein the training the generative ML model comprises:
calculating a reconstruction loss between the reconstructed residual vector and the residual vector; and
adjusting the parameters of the VAE to minimise the calculated loss.

6. The method of claim 5, further comprising:
calculating an evidence lower bound loss which comprises a reconstruction loss and a prior matching term.

7. The method of claim 1,
wherein the generative ML model is a diffusion model comprising an encoder and a decoder, and
wherein the training the generative ML model comprises:
applying, using the encoder, noise to the calculated residual vector;
generating, using the decoder, a prediction of the noise which was added;
calculating a loss between the predicted noise and the applied noise; and
adjusting the parameters of the diffusion model to minimise the calculated loss.

8. The method of claim 1, further comprising:
outputting, to the user device, the set of base classes and base class prototype feature vectors when outputting the classification ML model.

9. A computer-implemented method for using, on the user device, the classification ML model generated of claim 1, comprising:
receiving, at the user device on which the classification ML model is stored together with a set of class prototypes, each of which is in the form of a prototype feature embedding vector which is representative of the class, an input image comprising an object to be classified;
extracting, using a backbone ML feature embedding model of the classification ML model, an input feature embedding vector for the input image comprising the object to be classified; and
for each prototype feature embedding vector of the set of class prototypes:
calculating a residual vector comprising a distance and a direction between the extracted input feature embedding vector and the prototype feature embedding vector;
inputting each calculated residual vector and associated prototype feature embedding vector into a generative ML model of the classification ML model to predict a reconstructed residual vector; and
calculating a similarity score between each calculated residual vector and the predicted reconstructed residual vector; and
outputting a predicted class for the input image based on the calculated similarity score.

10. The method of claim 9, further comprising:
comparing each similarity score to a threshold similarity score; and
when at least one similarity score is greater than or equal to the threshold, outputting the predicted class having a highest similarity score.

11. The method of claim 10, further comprising:
when all similarity scores are lower than a threshold, prompting a user to provide a label for a new class for the input image comprising the object to be classified.

12. The method of claim 9, further comprising:
receiving user feedback that an output predicted class for the input image is inaccurate; and
prompting a user to provide a label for a new class for the input image comprising the object to be classified.

13. The method of claim 9, further comprising:
receiving an input image with a label for a new class;
extracting using the backbone ML feature embedding model of the classification ML model, a feature embedding vector for the input image with the label for the new class; and
storing, in the set of class prototypes, the extracted feature embedding as a prototype feature embedding for the new class.

14. An electronic device comprising:
memory storing instructions; and
at least one processor operatively coupled to memory and comprising processing circuitry, wherein the at least one processor individually or collectively executes the instructions to cause the electronic device to:
obtain a backbone machine learning (ML) feature embedding model for generating feature embedding vectors for images, wherein the backbone ML feature embedding model is associated with a set of base classes and each base class in the set of base classes has a base class prototype in the form of a feature embedding vector which is representative of the base class;
obtain a training dataset comprising a plurality of input images each of which has a label corresponding to a base class from the set of base classes;
obtain a generative ML model;
generate, using multiple input images in the training dataset, training data for the generative ML model by:
for each input image in the multiple input images:
extracting, using the backbone ML feature embedding model, an input feature embedding vector for the input image;
selecting the prototype feature embedding vector corresponding to the base class label for the input image;
calculating a residual vector comprising a distance and a direction between the extracted input feature embedding vector and the selected prototype feature embedding vector in a feature space which is defined by input feature embedding vectors extracted for the multiple input images; and
associating the calculated residual vector with the selected prototype feature embedding vector as an instance of the training data for the generative ML model;
train, using the training data comprising calculated residual vectors and associated prototype feature embedding vectors, the generative ML model to generate a reconstructed residual vector; and
output a classification ML model, comprising the backbone ML feature embedding model and the trained generative ML model, to a user device.

15. The electronic device of claim 14, wherein the at least one processor individually or collectively executes the instructions to cause the electronic device to:
divide the plurality of input images in the training dataset into a support set and a query set,
wherein the support set and the query set each contain one or more input images of each known base class and wherein the multiple input images are the query set.

16. The electronic device of claim 14, wherein the at least one processor individually or collectively executes the instructions to cause the electronic device to select the prototype feature embedding vector generated using a support set.

17. The electronic device of claim 14, wherein the at least one processor individually or collectively executes the instructions to cause the electronic device to:
generate, using a support set, the prototype feature embedding vector for each base class by:
identifying each image in the support set which is labelled with the base class;
extracting, using the backbone ML feature embedding model, a feature embedding vector for each identified input image; and
calculating a mean feature vector from the extracted feature embedding vectors, wherein the calculated mean feature vector is the prototype feature embedding vector.

18. The electronic device of claim 14,
wherein the generative ML model is a variational autoencoder (VAE) comprising an encoder and a decoder, and
wherein the at least one processor individually or collectively executes the instructions to cause the electronic device to:
calculate a reconstruction loss between the reconstructed residual vector and the residual vector; and
adjust the parameters of the VAE to minimise the calculated loss.

19. The electronic device of claim 14, wherein the at least one processor individually or collectively executes the instructions to cause the electronic device to:
calculate an evidence lower bound loss which comprises a reconstruction loss and a prior matching term.

20. A non-transitory computer-readable storage medium comprising instructions which, when executed by at least one processor, causes the at least one processor to:
obtain a backbone machine learning (ML) feature embedding model for generating feature embedding vectors for images, wherein the backbone ML feature embedding model is associated with a set of base classes and each base class in the set of base classes has a base class prototype in the form of a feature embedding vector which is representative of the base class;
obtain a training dataset comprising a plurality of input images each of which has a label corresponding to a base class from the set of base classes;
obtain a generative ML model;
generate, using multiple input images in the training dataset, training data for the generative ML model by:
for each input image in the multiple input images:
extracting, using the backbone ML feature embedding model, an input feature embedding vector for the input image;
selecting the prototype feature embedding vector corresponding to the base class label for the input image;
calculating a residual vector comprising a distance and a direction between the extracted input feature embedding vector and the selected prototype feature embedding vector in a feature space which is defined by input feature embedding vectors extracted for the multiple input images; and
associating the calculated residual vector with the selected prototype feature embedding vector as an instance of the training data for the generative ML model;
train, using the training data comprising calculated residual vectors and associated prototype feature embedding vectors, the generative ML model to generate a reconstructed residual vector; and
output a classification ML model, comprising the backbone ML feature embedding model and the trained generative ML model, to a user device.
